(19) United States
(12) Patent Application Publication
(10) Pub. No.: US 2024/0381055 A1
(43) Pub. Date: Nov. 14, 2024

(54) CONFIGURATION SWITCHING TECHNIQUES FOR MULTICAST RECEPTION

(71) Applicant: QUALCOMM Incorporated, San Diego, CA (US)

(72) Inventors: Umesh PHUYAL, San Diego, CA (US); Le LIU, San Jose, CA (US); Prasada Veera Reddy KADIRI, San Diego, CA (US)

(21) Appl. No.: 18/657,597

(22) Filed: May 7, 2024

Related U.S. Application Data
(60) Provisional application No. 63/501,315, filed on May 10, 2023.

(51) Int. Cl. H04W 4/06; H04W 76/27

(52) U.S. Cl. CPC H04W 4/06; H04W 76/27

(57) ABSTRACT

Methods, systems, and devices for wireless communication are described. A user equipment (UE) may receive a radio resource control (RRC) release message that indicates a first point-to-multipoint (PTM) configuration for a multicast service provided by a serving cell of the UE. The first PTM configuration may identify a first set of resources to monitor for the multicast service while the UE is in an RRC inactive state. The RRC release message may further indicate whether a second PTM configuration is present for the serving cell of the UE, whether the second PTM configuration is different from the first PTM configuration, or both. The UE may monitor the serving cell for the multicast service in accordance with the first PTM configuration or the second PTM configuration based on transitioning from an RRC connected state to the RRC inactive state in accordance with the RRC release message.

### CROSS REFERENCE

The present application for patent claims the benefit of U.S. Provisional Patent Application No. 63/501,315 by PHUYAL et al., entitled “CONFIGURATION SWITCHING TECHNIQUES FOR MULTICAST RECEPTION,” filed May 10, 2023, assigned to the assignee hereof, and expressly incorporated by reference herein.

### FIELD OF TECHNOLOGY

The following relates to wireless communication, including configuration switching techniques for multicast reception.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support configuration switching techniques for multicast reception. In accordance with the techniques described herein, a user equipment (UE) may receive a radio resource control (RRC) release message that indicates a first point-to-multipoint (PTM) configuration for a multicast service provided by a serving cell of the UE. The first PTM configuration may identify a first set of resources to monitor for the multicast service while the UE is in an RRC inactive state. The RRC release message may further indicate whether a second PTM configuration for the multicast service is present for the serving cell of the UE, whether the second PTM configuration is different from the first PTM configuration, or both. The UE may monitor for the multicast service in accordance with the first PTM configuration or the second PTM configuration based on transitioning from an RRC connected state to the RRC inactive state in accordance with the RRC release message.

A method for wireless communications at a UE is described. The method may include: receiving, via an RRC release message, an indication of a first PTM configuration for a multicast service provided by a serving cell of the UE, the first PTM configuration identifying a first set of resources to monitor for the multicast service while the UE is in an RRC inactive state; receiving, via the RRC release message, an indication of whether a second PTM configuration for the multicast service is present for the serving cell of the UE, an indication of whether the second PTM configuration is different from the first PTM configuration, or both; and monitoring for the multicast service in accordance with the first PTM configuration or the second PTM configuration based on transitioning from an RRC connected state to the RRC inactive state in accordance with the RRC release message.

An apparatus for wireless communications at a UE is described. The apparatus may include a processor, memory coupled with the processor, and instructions stored in the memory. The instructions may be executable by the processor to cause the apparatus to: receive, via an RRC release message, an indication of a first PTM configuration for a multicast service provided by a serving cell of the UE, the first PTM configuration identifying a first set of resources to monitor for the multicast service while the UE is in an RRC inactive state; receive, via the RRC release message, an indication of whether a second PTM configuration for the multicast service is present for the serving cell of the UE, an indication of whether the second PTM configuration is different from the first PTM configuration, or both; and monitor for the multicast service in accordance with the first PTM configuration or the second PTM configuration based on transitioning from an RRC connected state to the RRC inactive state in accordance with the RRC release message.

Another apparatus for wireless communications at a UE is described. The apparatus may include: means for receiving, via an RRC release message, an indication of a first PTM configuration for a multicast service provided by a serving cell of the UE, the first PTM configuration identifying a first set of resources to monitor for the multicast service while the UE is in an RRC inactive state; means for receiving, via the RRC release message, an indication of whether a second PTM configuration for the multicast service is present for the serving cell of the UE, an indication of whether the second PTM configuration is different from the first PTM configuration, or both; and means for monitoring for the multicast service in accordance with the first PTM configuration or the second PTM configuration based on transitioning from an RRC connected state to the RRC inactive state in accordance with the RRC release message.

A non-transitory computer-readable medium storing code for wireless communications at a UE is described. The code may include instructions executable by a processor to: receive, via an RRC release message, an indication of a first PTM configuration for a multicast service provided by a serving cell of the UE, the first PTM configuration identifying a first set of resources to monitor for the multicast service while the UE is in an RRC inactive state; receive, via the RRC release message, an indication of whether a second PTM configuration for the multicast service is present for the serving cell of the UE, an indication of whether the second PTM configuration is different from the first PTM configuration, or both; and monitor for the multicast service in accordance with the first PTM configuration or the second PTM configuration based on transitioning from an RRC connected state to the RRC inactive state in accordance with the RRC release message.

In some examples of the methods, apparatuses, and non-transitory computer-readable media described herein, monitoring for the multicast service may include operations, features, means, or instructions for monitoring for the multicast service in accordance with the first PTM configuration based on the RRC release message indicating that the second PTM configuration is the same as the first PTM configuration.

In some examples of the methods, apparatuses, and non-transitory computer-readable media described herein, monitoring for the multicast service may include operations, features, means, or instructions for monitoring for the multicast service in accordance with the first PTM configuration based on the RRC release message indicating that the second PTM configuration is absent for the serving cell of the UE.

In some examples of the methods, apparatuses, and non-transitory computer-readable media described herein, receiving the RRC release message may include operations, features, means, or instructions for receiving an indication of the first PTM configuration for the multicast service via dedicated signaling while the UE is in the RRC connected state.

In some examples of the methods, apparatuses, and non-transitory computer-readable media described herein, the indication of whether the second PTM configuration is present for the serving cell and whether the second PTM configuration is different from the first PTM configuration is applicable to a set of group radio network temporary identifiers (G-RNTIs). In some examples of the methods, apparatuses, and non-transitory computer-readable media described herein, the indication of whether the second PTM configuration is present for the serving cell and whether the second PTM configuration is different from the first PTM configuration is signaled per G-RNTI.

Some examples of the methods, apparatuses, and non-transitory computer-readable media described herein may further include operations, features, means, or instructions for monitoring for a multicast control channel (MCCH) change notification to determine whether a PTM configuration change has occurred for the multicast service. Some examples of the methods, apparatuses, and non-transitory computer-readable media described herein may further include operations, features, means, or instructions for receiving, while the UE is in the RRC inactive state, an indication of the second PTM configuration via an MCCH based on the RRC release message indicating that the second PTM configuration is different from the first PTM configuration.

Some examples of the methods, apparatuses, and non-transitory computer-readable media described herein may further include operations, features, means, or instructions for receiving a multicast system information block (SIB) or an MCCH transmission indicating the second PTM configuration for the multicast service after transitioning to the RRC inactive state.

In some examples of the methods, apparatuses, and non-transitory computer-readable media described herein, the first PTM configuration is valid while the UE is transitioning from the RRC connected state to the RRC inactive state.

Some examples of the methods, apparatuses, and non-transitory computer-readable media described herein may further include operations, features, means, or instructions for periodically monitoring an MCCH to acquire the second PTM configuration for the multicast service provided by the serving cell of the UE.

Some examples of the methods, apparatuses, and non-transitory computer-readable media described herein may further include operations, features, means, or instructions for switching or updating a configuration of a multicast radio bearer (MRB) associated with the multicast service based on periodically monitoring the MCCH.

Some examples of the methods, apparatuses, and non-transitory computer-readable media described herein may further include operations, features, means, or instructions for determining a time period for which the first PTM configuration is valid.

In some examples of the methods, apparatuses, and non-transitory computer-readable media described herein, monitoring for the multicast service may include operations, features, means, or instructions for monitoring for the multicast service in accordance with the first PTM configuration prior to expiration of the time period and monitoring for the multicast service in accordance with the second PTM configuration after expiration of the time period.

Some examples of the methods, apparatuses, and non-transitory computer-readable media described herein may further include operations, features, means, or instructions for refraining from monitoring an MCCH associated with the multicast service until the time period has elapsed.

Some examples of the methods, apparatuses, and non-transitory computer-readable media described herein may further include operations, features, means, or instructions for switching from a first MRB configuration associated with the first PTM configuration to a second MRB configuration associated with the second PTM configuration prior to expiration of the time period.

In some examples of the methods, apparatuses, and non-transitory computer-readable media described herein, a duration of the time period is fixed, configurable, configured by default, or equal to zero.

Some examples of the methods, apparatuses, and non-transitory computer-readable media described herein may further include operations, features, means, or instructions for refraining from switching to an MRB configuration associated with the second PTM configuration if the multicast service is stopped, deactivated, or temporarily suspended, where the MRB configuration is provided via an MCCH.

Some examples of the methods, apparatuses, and non-transitory computer-readable media described herein may further include operations, features, means, or instructions for receiving, while the UE is in the RRC connected state, an RRC reconfiguration message that indicates an MRB configuration associated with the first PTM configuration for the multicast service, where the RRC release message instructs the UE to re-use the MRB configuration for reception of the multicast service while the UE is in the RRC inactive state.

In some examples of the methods, apparatuses, and non-transitory computer-readable media described herein, the RRC release message further instructs the UE to release a point-to-point (P2P) configuration or to deactivate a P2P leg of the MRB configuration provided via the RRC reconfiguration message.

Some examples of the methods, apparatuses, and non-transitory computer-readable media described herein may further include operations, features, means, or instructions for receiving an indication of a time duration for which the MRB configuration is valid and monitoring for the multicast service in accordance with the MRB configuration until the time duration has elapsed.

A method for wireless communications at a network entity is described. The method may include: transmitting, via an RRC release message for a UE in an RRC connected state, an indication of a first PTM configuration for a multicast service provided by a cell associated with the network entity, the first PTM configuration identifying a first set of resources to monitor for the multicast service; transmitting, via the RRC release message, an indication of whether a second PTM configuration for the multicast service is present for the cell, an indication of whether the second PTM configuration is different from the first PTM configuration, or both; and transmitting one or more messages associated with the multicast service in accordance with the first PTM configuration or the second PTM configuration based on the RRC release message instructing the UE to transition from the RRC connected state to an RRC inactive state.

An apparatus for wireless communications at a network entity is described. The apparatus may include a processor, memory coupled with the processor, and instructions stored in the memory. The instructions may be executable by the processor to cause the apparatus to: transmit, via an RRC release message for a UE in an RRC connected state, an indication of a first PTM configuration for a multicast service provided by a cell associated with the network entity, the first PTM configuration identifying a first set of resources to monitor for the multicast service; transmit, via the RRC release message, an indication of whether a second PTM configuration for the multicast service is present for the cell, an indication of whether the second PTM configuration is different from the first PTM configuration, or both; and transmit one or more messages associated with the multicast service in accordance with the first PTM configuration or the second PTM configuration based on the RRC release message instructing the UE to transition from the RRC connected state to an RRC inactive state.

Another apparatus for wireless communications at a network entity is described. The apparatus may include: means for transmitting, via an RRC release message for a UE in an RRC connected state, an indication of a first PTM configuration for a multicast service provided by a cell associated with the network entity, the first PTM configuration identifying a first set of resources to monitor for the multicast service; means for transmitting, via the RRC release message, an indication of whether a second PTM configuration for the multicast service is present for the cell, an indication of whether the second PTM configuration is different from the first PTM configuration, or both; and means for transmitting one or more messages associated with the multicast service in accordance with the first PTM configuration or the second PTM configuration based on the RRC release message instructing the UE to transition from the RRC connected state to an RRC inactive state.

A non-transitory computer-readable medium storing code for wireless communications at a network entity is described. The code may include instructions executable by a processor to: transmit, via an RRC release message for a UE in an RRC connected state, an indication of a first PTM configuration for a multicast service provided by a cell associated with the network entity, the first PTM configuration identifying a first set of resources to monitor for the multicast service; transmit, via the RRC release message, an indication of whether a second PTM configuration for the multicast service is present for the cell, an indication of whether the second PTM configuration is different from the first PTM configuration, or both; and transmit one or more messages associated with the multicast service in accordance with the first PTM configuration or the second PTM configuration based on the RRC release message instructing the UE to transition from the RRC connected state to an RRC inactive state.

In some examples of the methods, apparatuses, and non-transitory computer-readable media described herein, transmitting the one or more messages associated with the multicast service may include operations, features, means, or instructions for transmitting the one or more messages associated with the multicast service in accordance with the first PTM configuration based on the RRC release message indicating that the second PTM configuration is the same as the first PTM configuration.

In some examples of the methods, apparatuses, and non-transitory computer-readable media described herein, transmitting the one or more messages associated with the multicast service may include operations, features, means, or instructions for transmitting the one or more messages associated with the multicast service in accordance with the first PTM configuration based on the RRC release message indicating that the second PTM configuration is absent for the cell.

In some examples of the methods, apparatuses, and non-transitory computer-readable media described herein, transmitting the RRC release message may include operations, features, means, or instructions for transmitting an indication of the first PTM configuration to the UE via dedicated signaling while the UE is in the RRC connected state.

In some examples of the methods, apparatuses, and non-transitory computer-readable media described herein, the indication of whether the second PTM configuration is present for the cell and whether the second PTM configuration is different from the first PTM configuration applies to a set of G-RNTIs. In some examples of the methods, apparatuses, and non-transitory computer-readable media described herein, the indication of whether the second PTM configuration is present for the cell and whether the second PTM configuration is different from the first PTM configuration is signaled per G-RNTI.

Some examples of the methods, apparatuses, and non-transitory computer-readable media described herein may further include operations, features, means, or instructions for transmitting, via an MCCH, an indication of the second PTM configuration for the UE in the RRC inactive state based on the RRC release message indicating that the second PTM configuration is different from the first PTM configuration.

A method for wireless communications by a UE is described. The method may include receiving an indication of a first PTM configuration for a multicast service provided by a serving cell of the UE, the first PTM configuration identifying a first set of resources to monitor for the multicast service while the UE is in a RRC inactive state, receiving an RRC release message, and receiving one or more messages associated with the multicast service in accordance with the first PTM configuration or a second PTM configuration based on a transition from an RRC connected state to the RRC inactive state in accordance with the RRC release message.

A UE for wireless communications is described. The UE may include one or more memories storing processor executable code, and one or more processors coupled with the one or more memories. The one or more processors may individually or collectively be operable to execute the code to cause the UE to receive an indication of a first PTM configuration for a multicast service provided by a serving cell of the UE, the first PTM configuration identifying a first set of resources to monitor for the multicast service while the UE is in an RRC inactive state, receive an RRC release message, and receive one or more messages associated with the multicast service in accordance with the first PTM configuration or a second PTM configuration based on a transition from an RRC connected state to the RRC inactive state in accordance with the RRC release message.

Another UE for wireless communications is described. The UE may include means for receiving an indication of a first PTM configuration for a multicast service provided by a serving cell of the UE, the first PTM configuration identifying a first set of resources to monitor for the multicast service while the UE is in an RRC inactive state, means for receiving an RRC release message, and means for receiving one or more messages associated with the multicast service in accordance with the first PTM configuration or a second PTM configuration based on a transition from an RRC connected state to the RRC inactive state in accordance with the RRC release message.

A non-transitory computer-readable medium storing code for wireless communications is described. The code may include instructions executable by one or more processors to receive an indication of a first PTM configuration for a multicast service provided by a serving cell of the UE, the first PTM configuration identifying a first set of resources to monitor for the multicast service while the UE is in an RRC inactive state, receive an RRC release message, and receive one or more messages associated with the multicast service in accordance with the first PTM configuration or a second PTM configuration based on a transition from an RRC connected state to the RRC inactive state in accordance with the RRC release message.

An apparatus for wireless communications at a UE is described. The apparatus may include one or more processors, memory coupled with the one or more processors, instructions stored in the memory and executable by the one or more processors to cause the apparatus to, receive an indication of a first PTM configuration for a multicast service provided by a serving cell of the UE, the first PTM configuration identifying a first set of resources to monitor for the multicast service while the UE is in an RRC inactive state, receive an RRC release message, and receive one or more messages associated with the multicast service in accordance with the first PTM configuration or a second PTM configuration based on a transition from an RRC connected state to the RRC inactive state in accordance with the RRC release message.

In some examples of the apparatus, the indication of the second PTM configuration may be received via the RRC release message and where the one or more messages associated with the multicast service may be received in accordance with the second PTM configuration. In some examples of the apparatus, the instructions may be further executable by the one or more processors to cause the apparatus to monitor for a multicast control channel change notification to determine whether a PTM configuration change has occurred for the multicast service.

In some examples of the apparatus, the instructions may be further executable by the one or more processors to cause the apparatus to receive the multicast control channel change notification, where the indication of the second PTM configuration may be received via a multicast control channel based on receiving the multicast control channel change notification, and where the one or more messages associated with the multicast service may be received in accordance with the second PTM configuration.

In some examples of the apparatus, to receive the one or more messages associated with the multicast service, the instructions may be executable by the one or more processors to cause the apparatus to receive the one or more messages associated with the multicast service in accordance with the first PTM configuration based on the RRC release message indicating that the second PTM configuration may be the same as the first PTM configuration.

In some examples of the apparatus, to monitor for the multicast service, the instructions may be executable by the one or more processors to cause the apparatus to receive the one or more messages associated with the multicast service in accordance with the first PTM configuration based on the RRC release message indicating that the second PTM configuration may be absent for the serving cell of the UE. In some examples of the apparatus, to receive the RRC release message, the instructions may be executable by the one or more processors to cause the apparatus to receive the RRC release message via dedicated signaling while the UE may be in the RRC connected state.

In some examples of the apparatus, the instructions may be further executable by the one or more processors to cause the apparatus to determine a time period for which the second PTM configuration may be valid. In some examples of the apparatus, to monitor for the multicast service, the instructions may be executable by the one or more processors to cause the apparatus to receive the one or more messages associated with the multicast service in accordance with the second PTM configuration prior to expiration of the time period and receive the one or more messages associated with the multicast service in accordance with the first PTM configuration after expiration of the time period. In some examples of the apparatus, the instructions may be further executable by the one or more processors to cause the apparatus to refrain from monitoring a multicast control channel associated with the multicast service until the time period may have elapsed.

In some examples of the apparatus, the instructions may be further executable by the one or more processors to cause the apparatus to switch from a first MRB configuration associated with the first PTM configuration to a second MRB configuration associated with the first PTM configuration prior to expiration of the time period. In some examples of the apparatus, a duration of the time period may be fixed, configurable, configured by default, or equal to zero. In some examples of the apparatus, the instructions may be further executable by the one or more processors to cause the apparatus to receive an indication of a time duration for which a MRB configuration may be valid and monitor for the multicast service in accordance with the MRB configuration until the time duration may have elapsed.

Another apparatus for wireless communications at a network entity is described. The apparatus may include one or more processors, memory coupled with the one or more processors, instructions stored in the memory and executable by the one or more processors to cause the apparatus to, transmit, for a UE in an RRC connected state, an indication of a first PTM configuration for a multicast service provided by a cell associated with the network entity, the first PTM configuration identifying a first set of resources to monitor for the multicast service, transmit an RRC release message, and transmit one or more messages associated with the multicast service in accordance with the first PTM configuration or a second PTM configuration based on the RRC release message instructing the UE to transition from the RRC connected state to an RRC inactive state.

In some examples of the apparatus, the indication of the second PTM configuration may be transmitted via the RRC release message and transmitting the one or more messages associated with the multicast service may be in accordance with the second PTM configuration. In some examples of the apparatus, the instructions may be further executable by the one or more processors to cause the apparatus to transmit a multicast control channel change notification, where the indication of the second PTM configuration may be transmitted via a multicast control channel, and where the one or more messages associated with the multicast service may be transmitted in accordance with the second PTM configuration.

In some examples of the apparatus, to transmit the one or more messages associated with the multicast service, the instructions may be executable by the one or more processors to cause the apparatus to transmit the one or more messages associated with the multicast service in accordance with the first PTM configuration based on the RRC release message indicating that the second PTM configuration may be the same as the first PTM configuration. In some examples of the apparatus, to transmit the one or more messages associated with the multicast service, the instructions may be executable by the one or more processors to cause the apparatus to transmit the one or more messages associated with the multicast service in accordance with the first PTM configuration based on the RRC release message indicating that the second PTM configuration may be absent for the cell.

In some examples of the apparatus, to transmit the RRC release message, the instructions may be executable by the one or more processors to cause the apparatus to transmit the RRC release message via dedicated signaling while the UE may be in the RRC connected state.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices). While some examples may or may not be specifically directed to use cases or applications, a wide assortment of applicability of described innovations may occur.

Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers). It is intended that innovations described herein may be practiced in a wide variety of devices, chip-level components, systems, distributed arrangements, and/or end-user devices of varying sizes, shapes, and constitution.

### BRIEF DESCRIPTION OF THE DRAWINGS

FIG. 1 shows an example of a wireless communications system that supports configuration switching techniques for multicast reception in accordance with one or more aspects of the present disclosure.

FIG. 2 shows an example of a network architecture that supports configuration switching techniques for multicast reception in accordance with one or more aspects of the present disclosure.

FIG. 3 shows an example of a wireless communications system that supports configuration switching techniques for multicast reception in accordance with one or more aspects of the present disclosure.

FIG. 4 shows an example of a process flow that supports configuration switching techniques for multicast reception in accordance with one or more aspects of the present disclosure.

FIGS. 5 and 6 show block diagrams of devices that support configuration switching techniques for multicast reception in accordance with one or more aspects of the present disclosure.

FIG. 7 shows a block diagram of a communications manager that supports configuration switching techniques for multicast reception in accordance with one or more aspects of the present disclosure.

FIG. 8 shows a diagram of a system including a device that supports configuration switching techniques for multicast reception in accordance with one or more aspects of the present disclosure.

FIGS. 9 and 10 show block diagrams of devices that support configuration switching techniques for multicast reception in accordance with one or more aspects of the present disclosure.

FIG. 11 shows a block diagram of a communications manager that supports configuration switching techniques for multicast reception in accordance with one or more aspects of the present disclosure.

FIG. 12 shows a diagram of a system including a device that supports configuration switching techniques for multicast reception in accordance with one or more aspects of the present disclosure.

FIGS. 13 and 14 show flowcharts illustrating methods that support configuration switching techniques for multicast reception in accordance with one or more aspects of the present disclosure.

### DETAILED DESCRIPTION

In some wireless communications systems, a user equipment (UE) may transition from a radio resource control (RRC) connected state to an RRC inactive state to conserve power during periods of inactivity. The UE may initiate the transition after receiving an RRC connection release message from a network entity. In some cases, the UE may be capable of or configured to receive a multicast broadcast service (MBS) while in the inactive state (e.g., RRC inactive state). As described herein, MBS may include multicast services, broadcast services, or both. As used herein, the phrase “multicast service” may refer to, in some examples, a “MBS multicast session”, and the phrase “multicast reception” may refer to, in some examples, “MBS multicast reception.” Accordingly, the phrase “multicast reception” may refer to the UE receiving or otherwise monitoring for one or more MBS multicast session(s).

To support reception of an MBS multicast session from an inactive state, the network entity may provide the UE with a point-to-multipoint (PTM) configuration in the RRC connection release message. The PTM configuration may indicate which resources to monitor for the MBS multicast session (and other relevant parameters). Upon receiving the RRC connection release message, the UE may switch to the RRC inactive state and monitor for the MBS multicast session according to the PTM configuration provided by the network entity.

The UE may be configured to receive the MBS multicast session via a cell of the network entity. In some cases, however, multiple PTM configurations may be present for the cell. For example, the network entity may periodically transmit, via a multicast control channel (MCCH), an indication of a second PTM configuration that pertains to UEs in an inactive state and/or UEs that are in the process of switching between cells. If, for example, the PTM configuration provided in the RRC connection release message is different from the second PTM configuration provided via the MCCH, it may be unclear which PTM configuration to use for reception of the MBS multicast session.

In accordance with aspects of the present disclosure, the network entity may include, within the RRC connection release message, an indication of whether a second PTM configuration is present for the cell and, if so, whether the second PTM configuration (provided via the MCCH) via is the same or different from the PTM configuration provided in the dedicated RRC connection release message to the UE. If the RRC connection release message indicates that no other PTM configuration is present for the cell, the UE may transition to an RRC inactive state and monitor the cell for the MBS multicast session in accordance with the first PTM configuration.

Similarly, if the RRC connection release message indicates that the first PTM configuration is the same as the second PTM configuration, the UE may continue using the first PTM configuration until the UE switches cells, returns to an RRC connected state, etc. However, if the RRC connection release message indicates that the second PTM configuration is different from the first PTM configuration, the UE may be configured to use the first PTM configuration for a fixed time duration, after which the UE may switch to the second PTM configuration. Additionally, or alternatively, the UE may be configured to use the first PTM configuration until the UE successfully transitions to the RRC inactive state. Once the transition is complete, the UE may switch to the second PTM configuration and monitor the cell accordingly.

Aspects of the disclosure are initially described in the context of wireless communications systems and process flows. Aspects of the disclosure are further illustrated by and described with reference to apparatus diagrams, system diagrams, and flowcharts that relate to configuration switching techniques for MBS multicast reception.

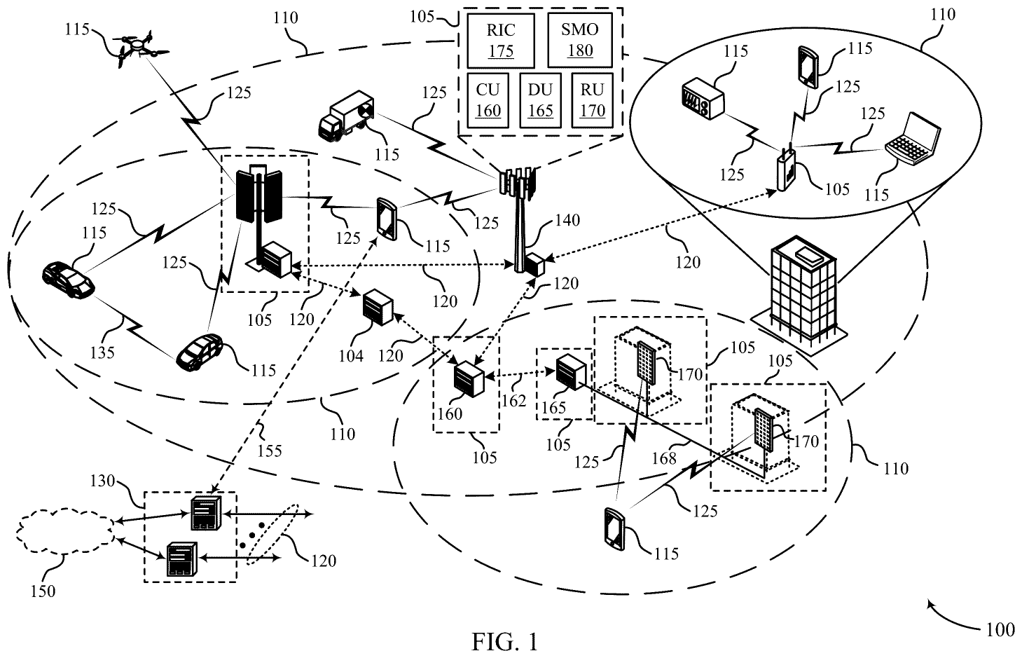

FIG. 1 shows an example of a wireless communications system 100 that supports configuration switching techniques for multicast reception in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115.

In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130).

In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof.

An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)).

The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170).

A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120).

IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support configuration switching techniques for multicast reception as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined PHY structure for supporting the communication links 125. For example, a carrier used for a communication link 125 may include a portion of a RF spectrum band (e.g., a bandwidth part (BWP)) that is operated according to one or more PHY channels for a given radio access technology (e.g., LTE, LTE-A, LTE-A Pro, NR). Each PHY channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation.

A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier.

One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In accordance with the techniques described herein, a UE 115 may receive, via an RRC connection release message, an indication of a first PTM configuration for a multicast service provided by a serving cell of the UE 115. The first PTM configuration may identify a first set of resources to monitor for the multicast service while the UE 115 is in an RRC inactive state. The UE 115 may also receive, via the RRC connection release message, an indication of whether a second PTM configuration for the multicast service is present for the serving cell of the UE 115, an indication of whether the second PTM configuration is different from the first PTM configuration, or both. The UE 115 may monitor the serving cell for the multicast service in accordance with the first PTM configuration or the second PTM configuration based on transitioning from an RRC connected state to the RRC inactive state according to the RRC connection release message.

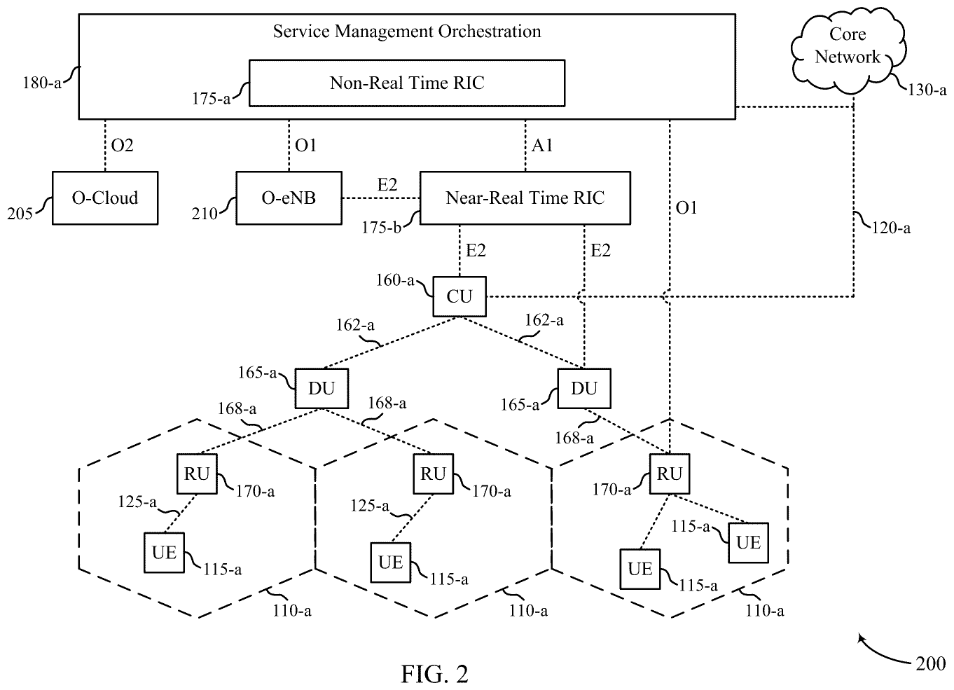

FIG. 2 shows an example of a network architecture 200 (e.g., a disaggregated base station architecture, a disaggregated RAN architecture) that supports configuration switching techniques for multicast reception in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an El interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (IFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an 02 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an Al interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., Al policies).

In accordance with the techniques described herein, the UE 115-a may receive, via an RRC connection release message, an indication of a first PTM configuration for a multicast service provided by a serving cell of the UE 115-a. The first PTM configuration may identify a first set of resources to monitor for the multicast service while the UE 115-a is in an RRC inactive state. The UE 115-a may also receive, via the RRC connection release message, an indication of whether a second PTM configuration for the multicast service is present for the serving cell of the UE 115-a, an indication of whether the second PTM configuration is different from the first PTM configuration, or both. The UE 115-a may monitor the serving cell for the multicast service in accordance with the first PTM configuration or the second PTM configuration after transitioning from an RRC connected state to the RRC inactive state in accordance with the RRC connection release message.

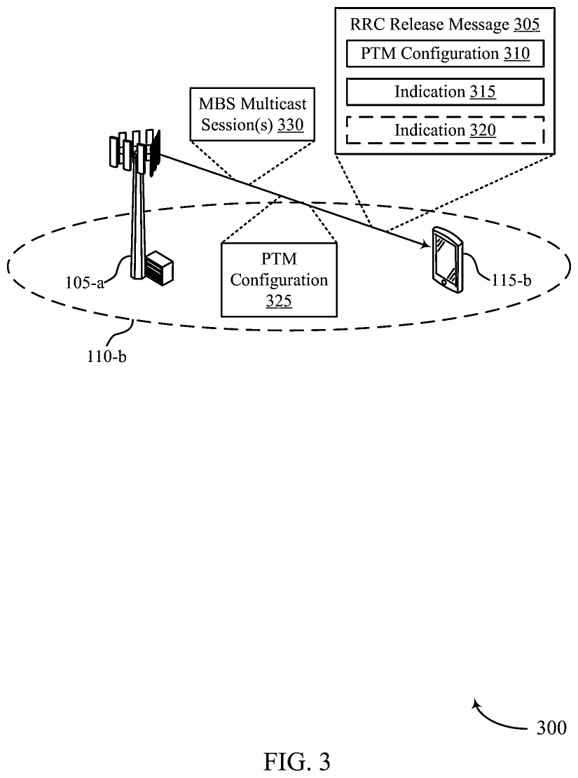

FIG. 3 shows an example of a wireless communications system 300 that supports configuration switching techniques for multicast reception in accordance with one or more aspects of the present disclosure. The wireless communications system 300 may implement or be implemented by aspects of the wireless communications system 100 or the network architecture 200. For example, the wireless communications system 300 includes a UE 115-b and a network entity 105-a, which may be examples of corresponding devices described with reference to FIGS. 1 and 2. The UE 115-b and the network entity 105-a may communicate within a coverage area 110-b, which may be an example of the coverage area 110-a described with reference to FIG. 2.

Some wireless communications systems (such as the wireless communications system 300) may support one or more MBS multicast session(s) 330. As described herein, MBS refers to a wireless communication technology that enables efficient distribution of content (such as audio, video, and data) to multiple UEs 115 simultaneously. MBS can be used to deliver live content to a large number of UEs 115 in a cost-effective manner. For some wireless communications systems that support MBS, only UEs 115 in an RRC_CONNECTED state can perform multicast reception. Other wireless communications systems (such as the wireless communications system 300) may support MBS multicast reception in an RRC_INACTIVE state. To facilitate MBS multicast reception from an RRC_INACTIVE state, the network entity 105-a may provide the UE 115-b with a PTM configuration 310 that indicates one or more MBS parameters (such as time/frequency resource information, bandwidth information, or coding information).

The PTM configuration 310 may be dedicatedly provided to the UE 115-b (in an RRC Connection Release message 305) while the UE 115-b is in RRC_CONNECTED and moving to RRC_INACTIVE. The PTM configuration 310 may be applicable to the current serving cell of the UE 115-b. Additionally, the network entity 105-a may use a system information block (SIB) or MCCH to provide a PTM configuration 325 for a different cell if, for example, the UE 115-b changes cells. In some examples, the network entity 105-a may transmit the SIB via the MCCH. The PTM configuration 325 may also be applicable to other UEs 115 that are already in RRC_INACTIVE when the multicast service starts/restarts. To acquire the PTM configuration 325, the network entity 105-a may instruct these UEs 115 to return to RRC_CONNECTED. Alternatively, the UEs 115 may be capable of or configured to read the SIB/MCCH from RRC_INACTIVE (i.e., without transitioning to RRC_CONNECTED).

In some cases, however, the UE 115-b (in RRC_CONNECTED) may receive the PTM configuration 310 via the RRC Connection Release message 305 while the network entity 105-a is concurrently providing the one or more MBS multicast session(s) 330 to other UEs 115 in RRC_INACTIVE after the SIB/MCCH (indicating the PTM configuration 325) is broadcasted. A cell may use the same or different PHY resources to deliver the same one or more MBS multicast session(s) 330 for RRC_CONNECTED and RRC_INACTIVE. As such, the UE 115-b may be unable to determine whether the PTM configuration 325 (indicated by the multicast SIB/MCCH) is the same or different from the PTM configuration 310 (indicated by the RRC Connection Release message).

If, for example, the PTM configuration 310 (i.e., the configuration provided via dedicated signaling) is different from the PTM configuration 325 (i.e., the configuration signaled via MCCH), it may be unclear if and when the MCCH-provided PTM configuration 325 takes precedence over the dedicatedly-provided PTM configuration 310. If the UE 115-b changes to a new cell, the UE 115-b may be configured to read the MCCH for the new cell. However, if the UE 115-b remains on the current serving cell, the dedicatedly-provided PTM configuration 310 may cease to be valid after some time. However, it may be unclear if and when the dedicatedly provided PTM configuration 310 ceases to be valid while the UE 115-b is in RRC_INACTIVE.

In accordance with aspects of the present disclosure, the network entity 105-a may include an indication 315 in the RRC Connection Release message 305, along with the PTM configuration 310, to indicate whether the MCCH-provided PTM configuration 325 is present for the cell. Additionally, or alternatively, the RRC Connection Release message 305 may include an indication 320 of whether the MCCH-provided PTM configuration 325 (if present) is the same or different from the dedicatedly-provided PTM configuration 310.

In some implementations, the UE 115-b may be unable to determine whether another configuration is present from MCCH content. In particular, UEs in an RRC_CONNECTED state may not have to read (i.e., decode) multicast MCCH transmissions to be able to receive multicast services (such as the one or more MBS multicast session(s) 330) from the network if, for example, the UE 115-b receives the PTM configuration 310 via dedicated signaling (such as the RRC Connection Release message 305). In some examples, the network entity 105-a may include one or both of the indication 315 or the indication 320 in dedicated signaling to the UE 115-b, since the network entity 105-a has access to MCCH content.

The indication 315 and/or the indication 320 (which can be signaled as flags in the RRC Connection Release message 305) may be common for different group radio network temporary identifiers (G-RNTIs), or may be separately configured per G-RNTI. After receiving the indication 315 and/or the indication 320, the UE 115-b can selectively monitor for MCCH changes to determine if the PTM configuration(s) have changed, thereby enabling the UE 115-b to save power and avoid unnecessary MCCH reception/decoding.

In some other implementations, the UE 115-b may be configured to acquire multicast SIB/MCCH from the network entity 105-a as soon as the UE 115-b moves to RRC_INACTIVE. In other words, if the UE 115-b receives the PTM configuration 310 in the RRC Connection Release message 305, the PTM configuration 310 may be valid during the transition from RRC_CONNECTED to RRC_INACTIVE (e.g., to avoid interruptions during the transition). Thereafter, the PTM configuration 310 may cease to be valid. In such implementations, the UE 115-b may continue monitoring MCCH (even without cell reselection) to obtain the latest configuration information. The UE 115-b may also switch or update a multicast radio bearer (MRB) configuration.

In other implementations, a time duration may be defined after which the dedicatedly-provided PTM configuration 310 ceases to be valid, regardless of whether the UE 115-b performs cell reselection. This time duration may be defined by or implemented as a validity timer for the dedicatedly-provided PTM configuration 310. Configuring such a time period may enable the UE 115-b to delay reading the MCCH, and may also help the UE 115-b avoid switching to an MCCH-provided MRB configuration if, for example, the multicast service is stopped, deactivated, or temporarily suspended, even if the MCCH-provided configuration differs from the configuration provided via dedicated signaling. Additionally, using a time duration to determine if and when to switch between PTM configurations may reduce the likelihood of the UE 115-b losing active multicast data by ensuring that the UE 115-b has enough time to switch between configurations (e.g., if the UE 115-b has to switch MRB configurations before the timer expires). The duration of the validity timer can be configurable. Alternatively, a fixed time duration can be configured beforehand.

In some examples, more than one of the approaches described herein can be combined. For example, the UE 115-b may periodically monitor the MCCH for the PTM configuration 325 after receiving one or both of the indication 315 or the indication 320 via the RRC Connection Release message 305. If the RRC Connection Release message 305 does not convey information pertaining to the PTM configuration 325, a timer may be configured by default. In some implementations, the duration of the timer may be set to 0 (in which case the UE 115-b may use the PTM configuration 325).

If, for example, an MRB configuration is provided in an RRC Reconfiguration message from the network entity 105-a, the RRC Connection Release message 305 may instruct the UE 115-b to reuse the same MRB PTM configuration, release a point-to-point (PTP) configuration, and/or deactivate a PTP leg. If such an indication is received by the UE 115-b, the indicated MRB configuration may, in some examples, cease to be valid after some time.

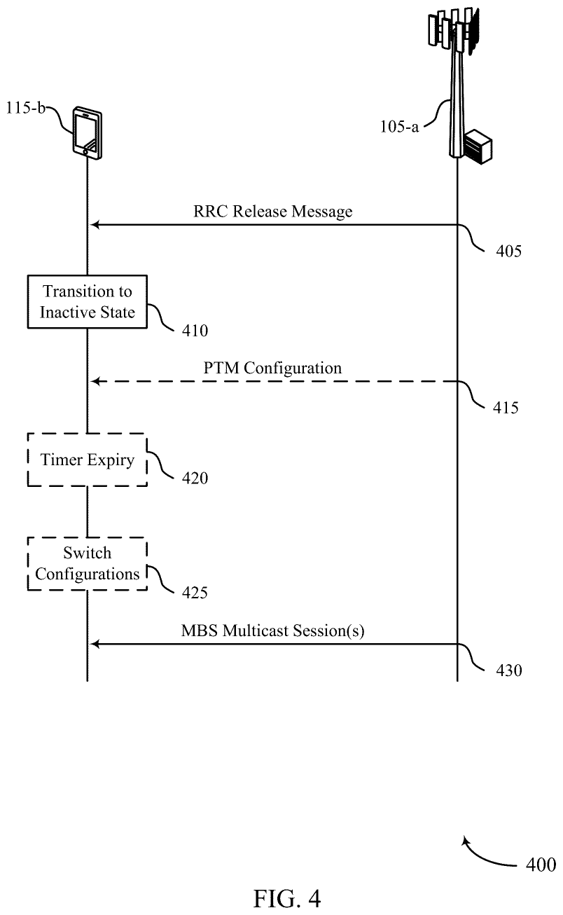

FIG. 4 shows an example of a process flow 400 that supports configuration switching techniques for multicast reception in accordance with one or more aspects of the present disclosure. The process flow 400 may implement or be implemented by aspects of the wireless communications system 100, the network architecture 200, or the wireless communications system 300. For example, the process flow 400 includes a UE 115-b and a network entity 105-a, which may be examples of corresponding devices described herein, including with reference to FIG. 3. In the following description of the process flow 400, operations between the UE 115-b and the network entity 105-a may be added, omitted, or performed in a different order (with respect to the exemplary order shown).

At 405, the network entity 105-a may transmit an RRC release message (such as the RRC Connection Release message 305 described with reference to FIG. 3) to the UE 115-b via a cell of the network entity 105-a. The RRC release message may include a first PTM configuration for the cell (such as the PTM configuration 310 described with reference to FIG. 3), an indication of whether a second PTM configuration (such as the PTM configuration 325 described with reference to FIG. 3) is present for the cell, an indication of whether the first PTM configuration is different from the second PTM configuration, or any combination thereof. As described herein, PTM refers to a mode of wireless communication by which a single transmitter (such as the network entity 105-a) communicates with multiple receivers (such as a group of communication devices including the UE 115-b) simultaneously. In contrast, PTP communications involve one transmitter communicating with one receiver via a dedicated channel.

The network entity 105-a may provide the first PTM configuration to the UE 115-b via dedicated signaling (e.g., a RRC connection release message). As described herein, the first PTM configuration may indicate a first set of time/frequency resources to monitor for a multicast service (e.g., one or more MBS multicast sessions), and the second PTM configuration may indicate a second set of time/frequency resources to monitor for the multicast service. In some examples, one or both of the first PTM configuration or the second PTM configuration may include other information related to the multicast information, such as bandwidth information, transmit power information, coding information, G-RNTI applicability information, etc.

At 410, the UE 115-b may transition from an RRC Connected state to an RRC Inactive state based on receiving the RRC release message from the network entity 105-a. In some examples, at 415, the UE 115-b may receive an indication of the second PTM configuration via a multicast SIB or MCCH transmission from the network entity 105-a. If the RRC release message from the network entity indicates that the second PTM configuration is absent (i.e., not being used) for the cell, the UE 115-b may refrain from acquiring the second PTM configuration for some time. Similarly, if the RRC release message indicates that the second PTM configuration is the same as the first PTM configuration, the UE 115-b may selectively monitor the MCCH to determine whether the second PTM configuration has changed.

In some examples, at 420, the UE 115-b may determine that a validity timer associated with the first PTM configuration has expired. A duration of the timer may be dynamically configured or configured by default. If the duration of the validity timer is set to 0, the UE 115-b may be configured to immediately acquire and use the second PTM after transitioning from RRC_CONNECTED to RRC_INACTIVE.

In some examples, at 425, the UE 115-b may switch from the first PTM configuration to the second PTM configuration. The UE 115-b may switch from the first PTM configuration to the second PTM configuration if the first PTM configuration ceases to be valid, which can occur if the UE 115-b determines (at 420) that a validity timer for the first PTM configuration has expired. In some implementations, switching from the first PTM configuration to the second PTM configuration may include switching from one MRB configuration to another.

At 430, the UE 115-b may receive the multicast service via the cell using first PTM configuration (provided via dedicated signaling) or the second PTM configuration (provided via an MCCH). For example, if the RRC release message indicates that a second PTM configuration is not present for the cell, the UE 115-b may receive the multicast service (such as the one or more MBS multicast session(s) 330 described with reference to FIG. 3) using the first PTM configuration provided by the network entity 105-a. Likewise, if the RRC release message indicates that the second PTM configuration is the same as the first PTM configuration, the UE 115-b may continue using the first PTM configuration until the first PTM configuration ceases to be valid or the second PTM configuration is changed. Alternatively, if the RRC release message indicates that the second PTM configuration is different from the first PTM configuration and the first PTM configuration is no longer valid, the UE 115-b may use the second PTM configuration to monitor the cell and receive the multicast service.

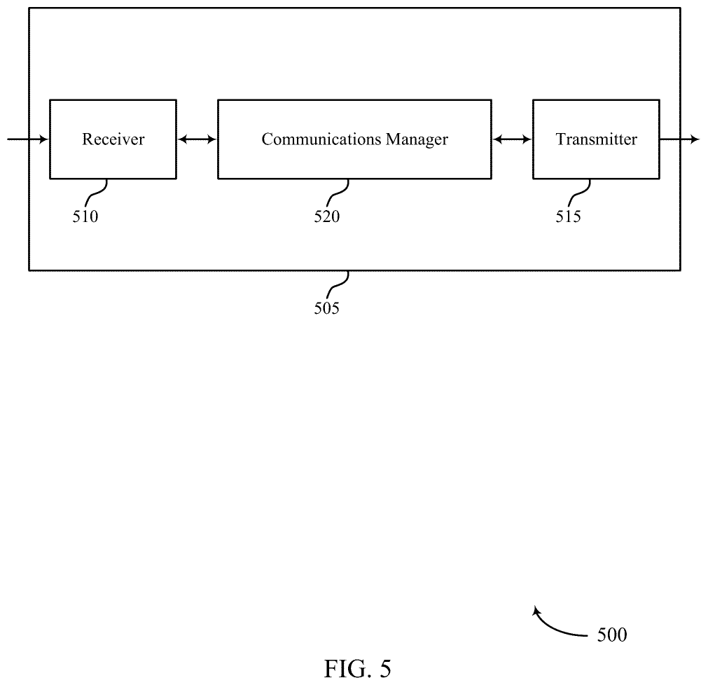

FIG. 5 shows a block diagram 500 of a device 505 that supports configuration switching techniques for multicast reception in accordance with one or more aspects of the present disclosure. The device 505 may be an example of aspects of a UE 115, as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to configuration switching techniques for multicast reception). Information may be passed on to other components of the device 505. The receiver 510 may utilize a single antenna or multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to configuration switching techniques for multicast reception). In some examples, the transmitter 515 may be co-located with a receiver 510 in a transceiver module. The transmitter 515 may utilize a single antenna or multiple antennas.

The communications manager 520, the receiver 510, the transmitter 515, or various combinations thereof or various components thereof may be examples of means for performing various aspects of configuration switching techniques for multicast reception as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE (such as the device 505) in accordance with examples disclosed herein. For example, the communications manager 520 is capable of, configured to, or operable to support a means for receiving, via an RRC release message, an indication of a first PTM configuration for a multicast service provided by a serving cell of the UE, the first PTM configuration identifying a first set of resources to monitor for the multicast service while the UE is in an RRC inactive state. The communications manager 520 is capable of, configured to, or operable to support a means for receiving, via the RRC release message, an indication of whether a second PTM configuration for the multicast service is present for the serving cell of the UE, an indication of whether the second PTM configuration is different from the first PTM configuration, or both. The communications manager 520 is capable of, configured to, or operable to support a means for monitoring for the multicast service in accordance with the first PTM configuration or the second PTM configuration based on transitioning from an RRC connected state to the RRC inactive state in accordance with the RRC release message.

The communications manager 520 may support wireless communications in accordance with examples as disclosed herein. For example, the communications manager 520 is capable of, configured to, or operable to support a means for receiving an indication of a first point-to-multipoint configuration for a multicast service provided by a serving cell of the UE, the first point-to-multipoint configuration identifying a first set of resources to monitor for the multicast service while the UE is in an RRC inactive state. The communications manager 520 is capable of, configured to, or operable to support a means for receiving an RRC release message. The communications manager 520 is capable of, configured to, or operable to support a means for receiving one or more messages associated with the multicast service in accordance with the first point-to-multipoint configuration or a second point-to-multipoint configuration based on a transition from an RRC connected state to the RRC inactive state in accordance with the RRC release message.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced processing, reduced power consumption, and more efficient utilization of communication resources, among other benefits.

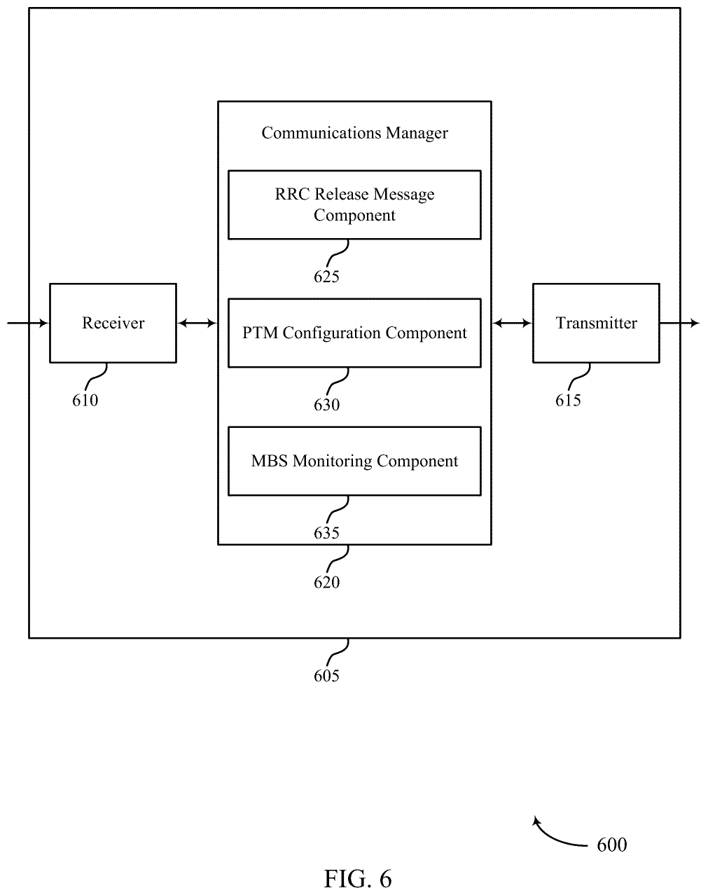

FIG. 6 shows a block diagram 600 of a device 605 that supports configuration switching techniques for multicast reception in accordance with one or more aspects of the present disclosure. The device 605 may be an example of aspects of a device 505 or a UE 115, as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to configuration switching techniques for multicast reception). Information may be passed on to other components of the device 605. The receiver 610 may utilize a single antenna or multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to configuration switching techniques for multicast reception). In some examples, the transmitter 615 may be co-located with a receiver 610 in a transceiver module. The transmitter 615 may utilize a single antenna or multiple antennas.

The device 605, or various components thereof, may be an example of means for performing various aspects of configuration switching techniques for multicast reception as described herein. For example, the communications manager 620 may include an RRC release message component 625, a PTM configuration component 630, an MBS monitoring component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE (such as the device 605) in accordance with examples disclosed herein. The RRC release message component 625 is capable of, configured to, or operable to support a means for receiving, via an RRC release message, an indication of a first PTM configuration for a multicast service provided by a serving cell of the UE, the first PTM configuration identifying a first set of resources to monitor for the multicast service while the UE is in an RRC inactive state. The PTM configuration component 630 is capable of, configured to, or operable to support a means for receiving, via the RRC release message, an indication of whether a second PTM configuration for the multicast service is present for the serving cell of the UE, an indication of whether the second PTM configuration is different from the first PTM configuration, or both. The MBS monitoring component 635 is capable of, configured to, or operable to support a means for monitoring for the multicast service in accordance with the first PTM configuration or the second PTM configuration based on transitioning from an RRC connected state to the RRC inactive state in accordance with the RRC release message.

The communications manager 620 may support wireless communications in accordance with examples as disclosed herein. The PTM configuration component 630 is capable of, configured to, or operable to support a means for receiving an indication of a first point-to-multipoint configuration for a multicast service provided by a serving cell of the UE, the first point-to-multipoint configuration identifying a first set of resources to monitor for the multicast service while the UE is in an RRC inactive state. The RRC release message component 625 is capable of, configured to, or operable to support a means for receiving an RRC release message. The MBS monitoring component 635 is capable of, configured to, or operable to support a means for receiving one or more messages associated with the multicast service in accordance with the first point-to-multipoint configuration or a second point-to-multipoint configuration based on a transition from an RRC connected state to the RRC inactive state in accordance with the RRC release message.

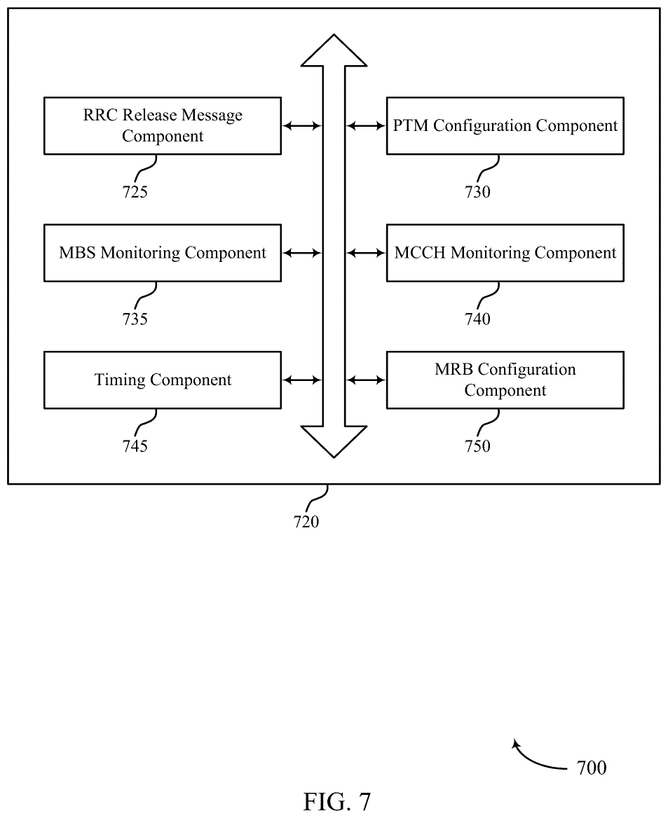

FIG. 7 shows a block diagram 700 of a communications manager 720 that supports configuration switching techniques for multicast reception in accordance with one or more aspects of the present disclosure. The communications manager 720 may be an example of aspects of a communications manager 520, a communications manager 620, or both, as described herein. The communications manager 720, or various components thereof, may be an example of means for performing various aspects of configuration switching techniques for multicast reception as described herein. For example, the communications manager 720 may include an RRC release message component 725, a PTM configuration component 730, an MBS monitoring component 735, an MCCH monitoring component 740, a timing component 745, an MRB configuration component 750, or any combination thereof. Each of these components may communicate, directly or indirectly, with one another (e.g., via one or more buses).

The communications manager 720 may support wireless communications at a UE (such as the UE 115-b described with reference to FIGS. 3 and 4) in accordance with examples disclosed herein. The RRC release message component 725 is capable of, configured to, or operable to support a means for receiving, via an RRC release message, an indication of a first PTM configuration for a multicast service provided by a serving cell of the UE, the first PTM configuration identifying a first set of resources to monitor for the multicast service while the UE is in an RRC inactive state. The PTM configuration component 730 is capable of, configured to, or operable to support a means for receiving, via the RRC release message, an indication of whether a second PTM configuration for the multicast service is present for the serving cell of the UE, an indication of whether the second PTM configuration is different from the first PTM configuration, or both. The MBS monitoring component 735 is capable of, configured to, or operable to support a means for monitoring for the multicast service in accordance with the first PTM configuration or the second PTM configuration based on transitioning from an RRC connected state to the RRC inactive state in accordance with the RRC release message.

The communications manager 720 may support wireless communications in accordance with examples as disclosed herein. The PTM configuration component 730 is capable of, configured to, or operable to support a means for receiving an indication of a first point-to-multipoint configuration for a multicast service provided by a serving cell of the UE, the first point-to-multipoint configuration identifying a first set of resources to monitor for the multicast service while the UE is in an RRC inactive state. The RRC release message component 725 is capable of, configured to, or operable to support a means for receiving an RRC release message. The MBS monitoring component 735 is capable of, configured to, or operable to support a means for receiving one or more messages associated with the multicast service in accordance with the first point-to-multipoint configuration or a second point-to-multipoint configuration based on a transition from an RRC connected state to the RRC inactive state in accordance with the RRC release message.

In some examples, the indication of the second point-to-multipoint configuration is received via the RRC release message. In some examples, the one or more messages associated with the multicast service is received in accordance with the second point-to-multipoint configuration.

In some examples, the MCCH monitoring component 740 is capable of, configured to, or operable to support a means for monitoring for a multicast control channel change notification to determine whether a point-to-multipoint configuration change has occurred for the multicast service.

In some examples, the MCCH monitoring component 740 is capable of, configured to, or operable to support a means for receiving the multicast control channel change notification, where the indication of the second point-to-multipoint configuration is received via a multicast control channel based on receiving the multicast control channel change notification, and where the one or more messages associated with the multicast service is received in accordance with the second point-to-multipoint configuration.

In some examples, to support monitoring for the multicast service, the MBS monitoring component 735 is capable of, configured to, or operable to support a means for monitoring the serving cell for the multicast service in accordance with the first PTM configuration based on the RRC release message indicating that the second PTM configuration is the same as the first PTM configuration.

In some examples, to support receiving the one or more messages associated with the multicast service, the PTM configuration component 730 is capable of, configured to, or operable to support a means for receiving the one or more messages associated with the multicast service in accordance with the first point-to-multipoint configuration based on the RRC release message indicating that the second point-to-multipoint configuration is the same as the first point-to-multipoint configuration.

In some examples, to support monitoring for the multicast service, the MBS monitoring component 735 is capable of, configured to, or operable to support a means for monitoring the serving cell for the multicast service in accordance with the first PTM configuration based on the RRC release message indicating that the second PTM configuration is absent for the serving cell of the UE.

In some examples, to support receiving the RRC release message, the RRC release message component 725 is capable of, configured to, or operable to support a means for receiving an indication of the first PTM configuration for the multicast service via dedicated signaling while the UE is in the RRC connected state.

In some examples, the indication of whether the second PTM configuration is present for the serving cell and whether the second PTM configuration is different from the first PTM configuration is applicable to multiple G-RNTIs.

In some examples, the indication of whether the second PTM configuration is present for the serving cell and whether the second PTM configuration is different from the first PTM configuration is signaled per G-RNTI.

In some examples, the MCCH monitoring component 740 is capable of, configured to, or operable to support a means for monitoring for a MCCH change notification to determine whether a PTM configuration change has occurred for the multicast service.

In some examples, the PTM configuration component 730 is capable of, configured to, or operable to support a means for receiving, while the UE is in the RRC inactive state, an indication of the second PTM configuration via a MCCH based on the RRC release message indicating that the second PTM configuration is different from the first PTM configuration.

In some examples, the PTM configuration component 730 is capable of, configured to, or operable to support a means for receiving a multicast SIB or a MCCH transmission indicating the second PTM configuration for the multicast service after transitioning to the RRC inactive state. In some examples, the first PTM configuration is valid while the UE is transitioning from the RRC connected state to the RRC inactive state.

In some examples, the MCCH monitoring component 740 is capable of, configured to, or operable to support a means for periodically monitoring a MCCH to acquire the second PTM configuration for the multicast service provided by the serving cell of the UE.

In some examples, the MRB configuration component 750 is capable of, configured to, or operable to support a means for switching or updating a configuration of an MRB associated with the multicast service based on periodically monitoring the MCCH. In some examples, the timing component 745 is capable of, configured to, or operable to support a means for determining a time period for which the first PTM configuration is valid.

In some examples, to support monitoring for the multicast service, the MBS monitoring component 735 is capable of, configured to, or operable to support a means for monitoring for the multicast service in accordance with the first PTM configuration prior to expiration of the time period. In some examples, to support monitoring for the multicast service, the MBS monitoring component 735 is capable of, configured to, or operable to support a means for monitoring for the multicast service in accordance with the second PTM configuration after expiration of the time period.

In some examples, the MCCH monitoring component 740 is capable of, configured to, or operable to support a means for refraining from monitoring a MCCH associated with the multicast service until the time period has elapsed.

In some examples, the MRB configuration component 750 is capable of, configured to, or operable to support a means for switching from a first MRB configuration associated with the first PTM configuration to a second MRB configuration associated with the second PTM configuration prior to expiration of the time period. In some examples, a duration of the time period is fixed, configurable, configured by default, or equal to zero.

In some examples, the MRB configuration component 750 is capable of, configured to, or operable to support a means for refraining from switching to an MRB configuration associated with the second PTM configuration if the multicast service is stopped, deactivated, or temporarily suspended, where the MRB configuration is provided via a MCCH.

In some examples, the MRB configuration component 750 is capable of, configured to, or operable to support a means for receiving, while the UE is in the RRC connected state, an RRC reconfiguration message that indicates an MRB configuration associated with the first PTM configuration for the multicast service, where the RRC release message instructs the UE to re-use the MRB configuration for reception of the multicast service while the UE is in the RRC inactive state.

In some examples, the RRC release message further instructs the UE to release a PTP configuration or to deactivate a point-to-point leg of the MRB configuration provided via the RRC reconfiguration message.

In some examples, the timing component 745 is capable of, configured to, or operable to support a means for receiving an indication of a time duration for which the MRB configuration is valid. In some examples, the MBS monitoring component 735 is capable of, configured to, or operable to support a means for monitoring for the multicast service in accordance with the MRB configuration until the time duration has elapsed.

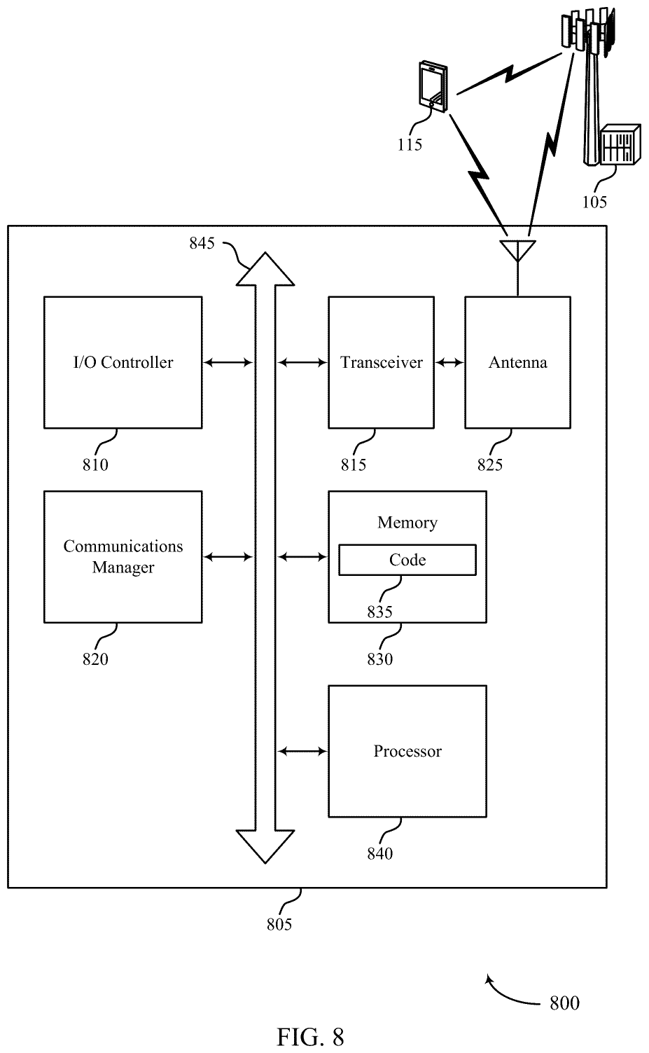

FIG. 8 shows a diagram of a system 800 including a device 805 that supports configuration switching techniques for multicast reception in accordance with one or more aspects of the present disclosure. The device 805 may be an example of or include the components of a device 505, a device 605, or a UE 115, as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting configuration switching techniques for multicast reception). For example, the device 805 or a component of the device 805 may include a processor 840 and memory 830 coupled with or to the processor 840, the processor 840 and memory 830 configured to perform various functions described herein.

The communications manager 820 may support wireless communications at a UE (such as the device 805) in accordance with examples disclosed herein. For example, the communications manager 820 is capable of, configured to, or operable to support a means for receiving, via an RRC release message, an indication of a first PTM configuration for a multicast service provided by a serving cell of the UE, the first PTM configuration identifying a first set of resources to monitor for the multicast service while the UE is in an RRC inactive state. The communications manager 820 is capable of, configured to, or operable to support a means for receiving, via the RRC release message, an indication of whether a second PTM configuration for the multicast service is present for the serving cell of the UE, an indication of whether the second PTM configuration is different from the first PTM configuration, or both. The communications manager 820 is capable of, configured to, or operable to support a means for monitoring for the multicast service in accordance with the first PTM configuration or the second PTM configuration based on transitioning from an RRC connected state to the RRC inactive state in accordance with the RRC release message.

The communications manager 820 may support wireless communications in accordance with examples as disclosed herein. For example, the communications manager 820 is capable of, configured to, or operable to support a means for receiving an indication of a first point-to-multipoint configuration for a multicast service provided by a serving cell of the UE, the first point-to-multipoint configuration identifying a first set of resources to monitor for the multicast service while the UE is in an RRC inactive state. The communications manager 820 is capable of, configured to, or operable to support a means for receiving an RRC release message. The communications manager 820 is capable of, configured to, or operable to support a means for receiving one or more messages associated with the multicast service in accordance with the first point-to-multipoint configuration or a second point-to-multipoint configuration based on a transition from an RRC connected state to the RRC inactive state in accordance with the RRC release message.

By including or configuring the communications manager 820 in accordance with examples as described herein, the device 805 may support techniques for improved communication reliability, reduced latency, reduced processing, reduced power consumption, more efficient utilization of communication resources, improved coordination between devices, longer battery life, and improved utilization of processing capability, among other benefits.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of configuration switching techniques for multicast reception as described herein, or the processor 840 and the memory 830 may be otherwise configured to perform or support such operations.

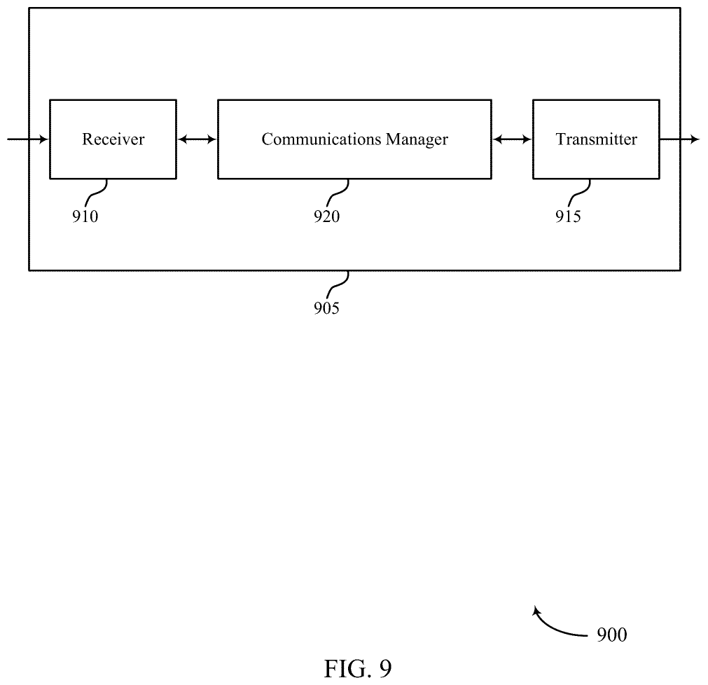

FIG. 9 shows a block diagram 900 of a device 905 that supports configuration switching techniques for multicast reception in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of configuration switching techniques for multicast reception as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity (such as the device 905) in accordance with examples disclosed herein. For example, the communications manager 920 is capable of, configured to, or operable to support a means for transmitting, via an RRC release message for a UE in an RRC connected state, an indication of a first PTM configuration for a multicast service provided by a cell associated with the network entity, the first PTM configuration identifying a first set of resources to monitor for the multicast service. The communications manager 920 is capable of, configured to, or operable to support a means for transmitting, via the RRC release message, an indication of whether a second PTM configuration for the multicast service is present for the cell, an indication of whether the second PTM configuration is different from the first PTM configuration, or both. The communications manager 920 is capable of, configured to, or operable to support a means for transmitting one or more messages associated with the multicast service in accordance with the first PTM configuration or the second PTM configuration based on the RRC release message instructing the UE to transition from the RRC connected state to an RRC inactive state.

The communications manager 920 may support wireless communications in accordance with examples as disclosed herein. For example, the communications manager 920 is capable of, configured to, or operable to support a means for transmitting, for a UE in an RRC connected state, an indication of a first point-to-multipoint configuration for a multicast service provided by a cell associated with the network entity, the first point-to-multipoint configuration identifying a first set of resources to monitor for the multicast service. The communications manager 920 is capable of, configured to, or operable to support a means for transmitting an RRC release message. The communications manager 920 is capable of, configured to, or operable to support a means for transmitting one or more messages associated with the multicast service in accordance with the first point-to-multipoint configuration or a second point-to-multipoint configuration based on the RRC release message instructing the UE to transition from the RRC connected state to an RRC inactive state.

By including or configuring the communications manager 920 in accordance with examples as described herein, the device 905 (e.g., a processor controlling or otherwise coupled with the receiver 910, the transmitter 915, the communications manager 920, or a combination thereof) may support techniques reduced processing, reduced power consumption, and more efficient utilization of communication resources, among other benefits.

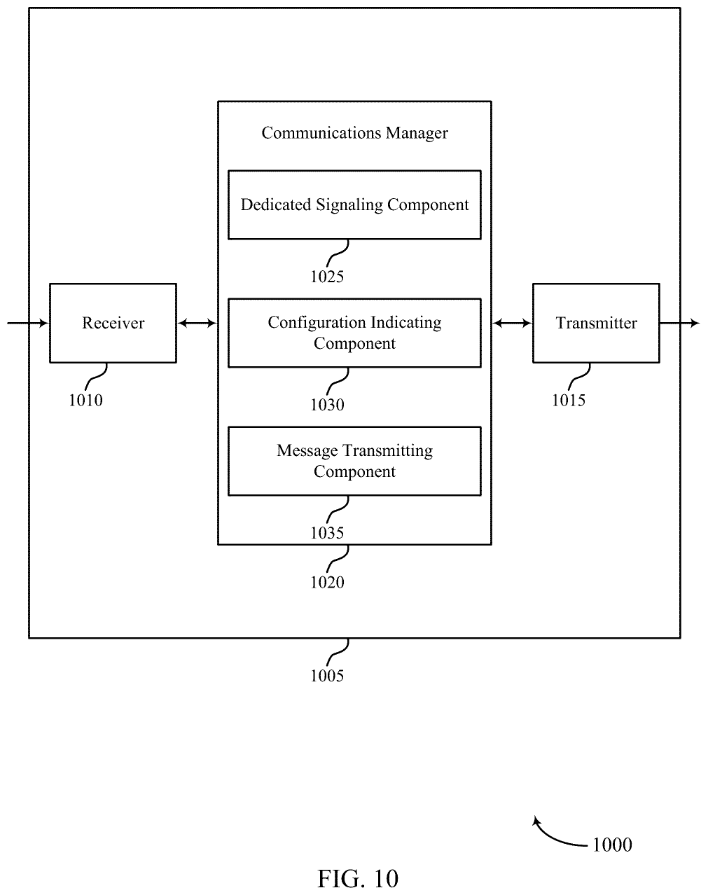

FIG. 10 shows a block diagram 1000 of a device 1005 that supports configuration switching techniques for multicast reception in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of configuration switching techniques for multicast reception as described herein. For example, the communications manager 1020 may include a dedicated signaling component 1025, a configuration indicating component 1030, a message transmitting component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity (such as the device 1005) in accordance with examples disclosed herein. The dedicated signaling component 1025 is capable of, configured to, or operable to support a means for transmitting, via an RRC release message for a UE in an RRC connected state, an indication of a first PTM configuration for a multicast service provided by a cell associated with the network entity, the first PTM configuration identifying a first set of resources to monitor for the multicast service. The configuration indicating component 1030 is capable of, configured to, or operable to support a means for transmitting, via the RRC release message, an indication of whether a second PTM configuration for the multicast service is present for the cell, an indication of whether the second PTM configuration is different from the first PTM configuration, or both. The message transmitting component 1035 is capable of, configured to, or operable to support a means for transmitting one or more messages associated with the multicast service in accordance with the first PTM configuration or the second PTM configuration based on the RRC release message instructing the UE to transition from the RRC connected state to an RRC inactive state.

The communications manager 1020 may support wireless communications in accordance with examples as disclosed herein. The configuration indicating component 1030 is capable of, configured to, or operable to support a means for transmitting, for a UE in an RRC connected state, an indication of a first point-to-multipoint configuration for a multicast service provided by a cell associated with the network entity, the first point-to-multipoint configuration identifying a first set of resources to monitor for the multicast service. The dedicated signaling component 1025 is capable of, configured to, or operable to support a means for transmitting an RRC release message. The message transmitting component 1035 is capable of, configured to, or operable to support a means for transmitting one or more messages associated with the multicast service in accordance with the first point-to-multipoint configuration or a second point-to-multipoint configuration based on the RRC release message instructing the UE to transition from the RRC connected state to an RRC inactive state.

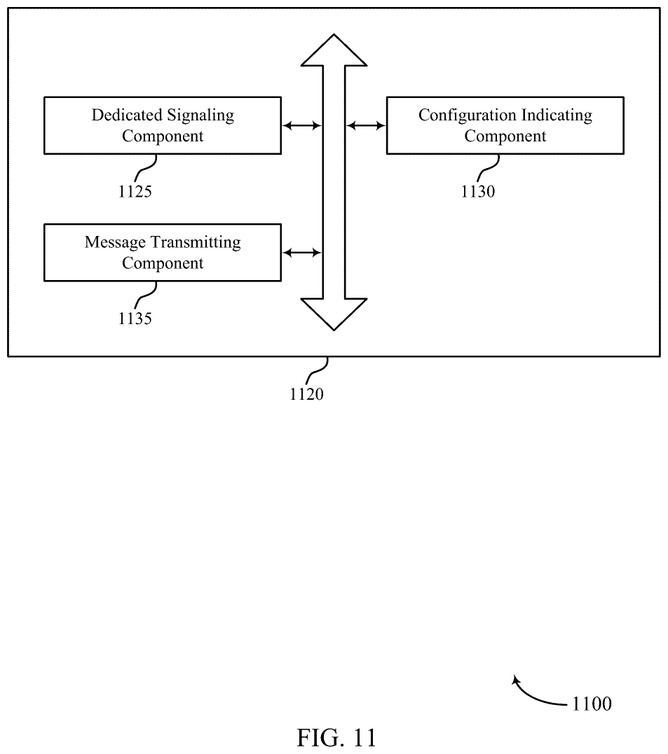

FIG. 11 shows a block diagram 1100 of a communications manager 1120 that supports configuration switching techniques for multicast reception in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of configuration switching techniques for multicast reception as described herein. For example, the communications manager 1120 may include a dedicated signaling component 1125, a configuration indicating component 1130, a message transmitting component 1135, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a network entity (such as the network entity 105-a described with reference to FIG. 3) in accordance with examples disclosed herein. The dedicated signaling component 1125 is capable of, configured to, or operable to support a means for transmitting, via an RRC release message for a UE in an RRC connected state, an indication of a first PTM configuration for a multicast service provided by a cell associated with the network entity, the first PTM configuration identifying a first set of resources to monitor for the multicast service. The configuration indicating component 1130 is capable of, configured to, or operable to support a means for transmitting, via the RRC release message, an indication of whether a second PTM configuration for the multicast service is present for the cell, an indication of whether the second PTM configuration is different from the first PTM configuration, or both. The message transmitting component 1135 is capable of, configured to, or operable to support a means for transmitting one or more messages associated with the multicast service in accordance with the first PTM configuration or the second PTM configuration based on the RRC release message instructing the UE to transition from the RRC connected state to an RRC inactive state.

The communications manager 1120 may support wireless communications in accordance with examples as disclosed herein. The configuration indicating component 1130 is capable of, configured to, or operable to support a means for transmitting, for a UE in an RRC connected state, an indication of a first point-to-multipoint configuration for a multicast service provided by a cell associated with the network entity, the first point-to-multipoint configuration identifying a first set of resources to monitor for the multicast service. The dedicated signaling component 1125 is capable of, configured to, or operable to support a means for transmitting an RRC release message. The message transmitting component 1135 is capable of, configured to, or operable to support a means for transmitting one or more messages associated with the multicast service in accordance with the first point-to-multipoint configuration or a second point-to-multipoint configuration based on the RRC release message instructing the UE to transition from the RRC connected state to an RRC inactive state.

In some examples, the indication of the second point-to-multipoint configuration is transmitted via the RRC release message. In some examples, the one or more messages associated with the multicast service is transmitted in accordance with the second point-to-multipoint configuration.

In some examples, the configuration indicating component 1125 is capable of, configured to, or operable to support a means for transmitting a multicast control channel change notification, where the indication of the second point-to-multipoint configuration is transmitted via a multicast control channel, and where the one or more messages associated with the multicast service is transmitted in accordance with the second point-to-multipoint configuration.

In some examples, to support transmitting the one or more messages associated with the multicast service, the message transmitting component 1135 is capable of, configured to, or operable to support a means for transmitting the one or more messages associated with the multicast service in accordance with the first PTM configuration based on the RRC release message indicating that the second PTM configuration is the same as the first PTM configuration.

In some examples, to support transmitting the one or more messages associated with the multicast service, the message transmitting component 1135 is capable of, configured to, or operable to support a means for transmitting the one or more messages associated with the multicast service in accordance with the first PTM configuration based on the RRC release message indicating that the second PTM configuration is absent for the cell.

In some examples, to support transmitting the RRC release message, the dedicated signaling component 1125 is capable of, configured to, or operable to support a means for transmitting an indication of the first PTM configuration to the UE via dedicated signaling while the UE is in the RRC connected state.

In some examples, the indication of whether the second PTM configuration is present for the cell and whether the second PTM configuration is different from the first PTM configuration applies to multiple G-RNTIs.

In some examples, the indication of whether the second PTM configuration is present for the cell and whether the second PTM configuration is different from the first PTM configuration is signaled per G-RNTI.

In some examples, the configuration indicating component 1130 is capable of, configured to, or operable to support a means for transmitting, via a MCCH, an indication of the second PTM configuration for the UE in the RRC inactive state based on the RRC release message indicating that the second PTM configuration is different from the first PTM configuration.

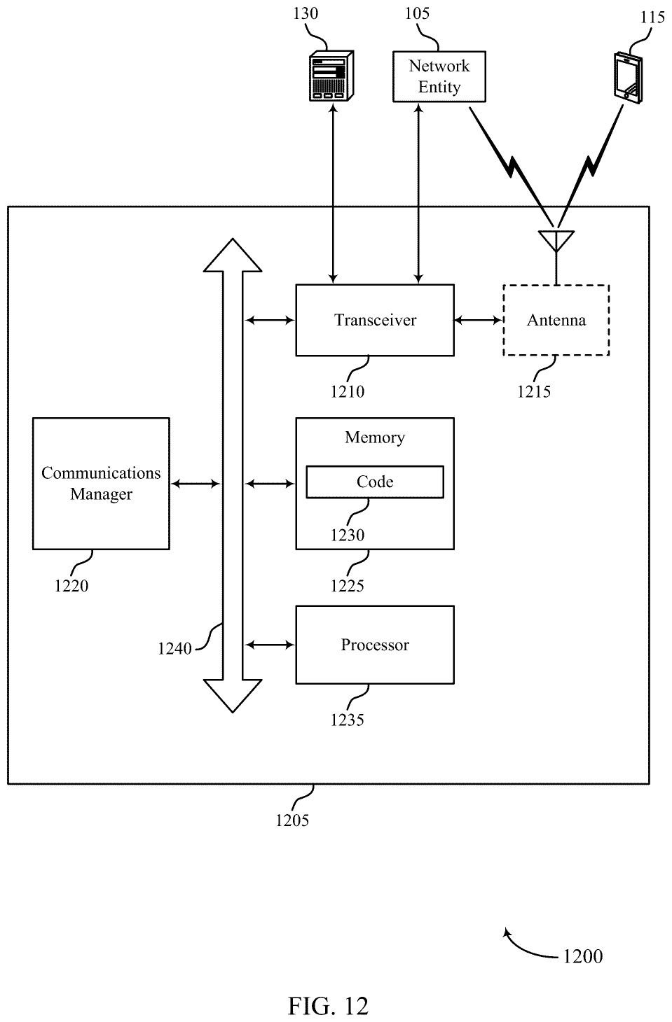

FIG. 12 shows a diagram of a system 1200 including a device 1205 that supports configuration switching techniques for multicast reception in accordance with one or more aspects of the present disclosure. The device 1205 may be an example of or include the components of a device 905, a device 1005, or a network entity 105, as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof.

In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting configuration switching techniques for multicast reception). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system.

A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations.

In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a network entity (such as the device 1205) in accordance with examples disclosed herein. For example, the communications manager 1220 is capable of, configured to, or operable to support a means for transmitting, via an RRC release message for a UE in an RRC connected state, an indication of a first PTM configuration for a multicast service provided by a cell associated with the network entity, the first PTM configuration identifying a first set of resources to monitor for the multicast service. The communications manager 1220 is capable of, configured to, or operable to support a means for transmitting, via the RRC release message, an indication of whether a second PTM configuration for the multicast service is present for the cell, an indication of whether the second PTM configuration is different from the first PTM configuration, or both. The communications manager 1220 is capable of, configured to, or operable to support a means for transmitting one or more messages associated with the multicast service in accordance with the first PTM configuration or the second PTM configuration based on the RRC release message instructing the UE to transition from the RRC connected state to an RRC inactive state.

The communications manager 1220 may support wireless communications in accordance with examples as disclosed herein. For example, the communications manager 1220 is capable of, configured to, or operable to support a means for transmitting, for a UE in an RRC connected state, an indication of a first point-to-multipoint configuration for a multicast service provided by a cell associated with the network entity, the first point-to-multipoint configuration identifying a first set of resources to monitor for the multicast service. The communications manager 1220 is capable of, configured to, or operable to support a means for transmitting an RRC release message. The communications manager 1220 is capable of, configured to, or operable to support a means for transmitting one or more messages associated with the multicast service in accordance with the first point-to-multipoint configuration or a second point-to-multipoint configuration based on the RRC release message instructing the UE to transition from the RRC connected state to an RRC inactive state.

By including or configuring the communications manager 1220 in accordance with examples as described herein, the device 1205 may support techniques for improved communication reliability, reduced processing, reduced power consumption, more efficient utilization of communication resources, improved coordination between devices, longer battery life, and improved utilization of processing capability.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of configuration switching techniques for multicast reception as described herein, or the processor 1235 and the memory 1225 may be otherwise configured to perform or support such operations.

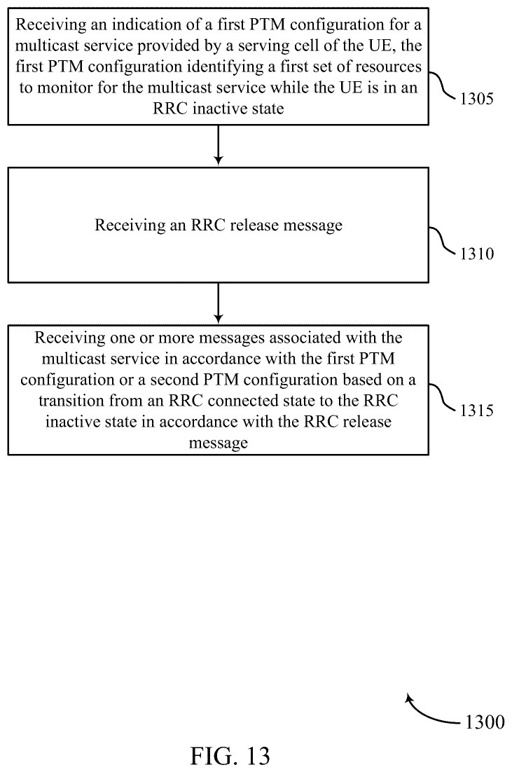

FIG. 13 shows a flowchart illustrating a method 1300 that supports configuration switching techniques for multicast reception in accordance with aspects of the present disclosure. The operations of the method 1300 may be implemented by a UE or components thereof. For example, the operations of the method 1300 may be performed by a UE 115, as described with reference to FIGS. 1 through 8. In some examples, the UE may execute a set of instructions to control the functional elements of the UE to perform the described functions. Additionally, or alternatively, the UE may perform aspects of the described functions using special-purpose hardware.

At 1305, the method may include receiving, via an RRC release message, an indication of a first PTM configuration for a multicast service provided by a serving cell of the UE, the first PTM configuration identifying a first set of resources to monitor for the multicast service while the UE is in an RRC inactive state. The operations of 1305 may be performed in accordance with examples disclosed herein. In some examples, aspects of the operations of 1305 may be performed by an RRC release message component 725, as described with reference to FIG. 7.

At 1305, the method may include receiving an indication of a first point-to-multipoint configuration for a multicast service provided by a serving cell of the UE, the first point-to-multipoint configuration identifying a first set of resources to monitor for the multicast service while the UE is in an RRC inactive state. The operations of 1305 may be performed in accordance with examples as disclosed herein. In some examples, aspects of the operations of 1305 may be performed by a PTM configuration component 730 as described with reference to FIG. 7.

At 1310, the method may include receiving an RRC release message. The operations of 1310 may be performed in accordance with examples as disclosed herein. In some examples, aspects of the operations of 1310 may be performed by an RRC release message component 725 as described with reference to FIG. 7.

At 1315, the method may include receiving one or more messages associated with the multicast service in accordance with the first point-to-multipoint configuration or a second point-to-multipoint configuration based on a transition from an RRC connected state to the RRC inactive state in accordance with the RRC release message. The operations of 1315 may be performed in accordance with examples as disclosed herein. In some examples, aspects of the operations of 1315 may be performed by an MBS monitoring component 735 as described with reference to FIG. 7.

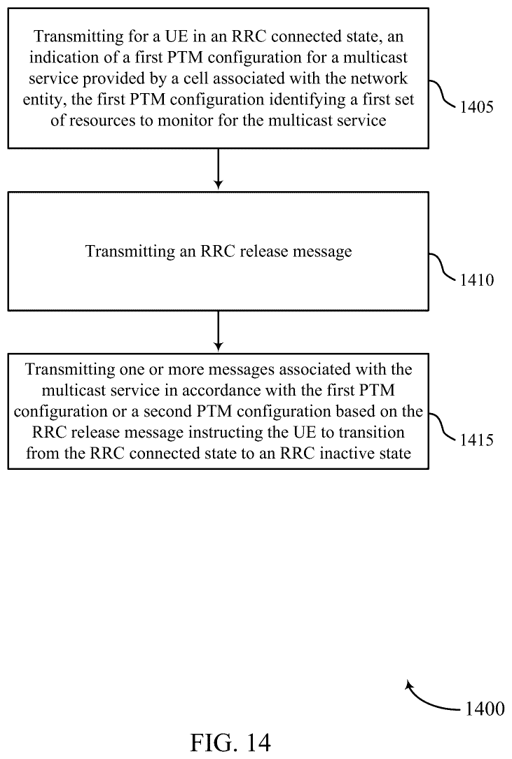

FIG. 14 shows a flowchart illustrating a method 1400 that supports configuration switching techniques for multicast reception in accordance with aspects of the present disclosure. The operations of the method 1400 may be implemented by a network entity or components thereof. For example, the operations of the method 1400 may be performed by a network entity 105, as described with reference to FIGS. 1 through 4 and 9 through 12. In some examples, the network entity may execute a set of instructions to control the functional elements of the network entity to perform the described functions. Additionally, or alternatively, the network entity may perform aspects of the described functions using special-purpose hardware.

At 1405, the method may include transmitting, for a UE in an RRC connected state, an indication of a first point-to-multipoint configuration for a multicast service provided by a cell associated with the network entity, the first point-to-multipoint configuration identifying a first set of resources to monitor for the multicast service. The operations of 1405 may be performed in accordance with examples as disclosed herein. In some examples, aspects of the operations of 1405 may be performed by a configuration indicating component 1130 as described with reference to FIG. 11.

At 1410, the method may include transmitting an RRC release message. The operations of 1410 may be performed in accordance with examples as disclosed herein. In some examples, aspects of the operations of 1410 may be performed by a dedicated signaling component 1125 as described with reference to FIG. 11.

At 1415, the method may include transmitting one or more messages associated with the multicast service in accordance with the first point-to-multipoint configuration or a second point-to-multipoint configuration based on the RRC release message instructing the UE to transition from the RRC connected state to an RRC inactive state. The operations of 1415 may be performed in accordance with examples as disclosed herein. In some examples, aspects of the operations of 1415 may be performed by a message transmitting component 1135 as described with reference to FIG. 11.

The following provides an overview of aspects of the present disclosure:
Aspect 1: A method for wireless communications at a UE, comprising: receiving, via an RRC release message, an indication of a first PTM configuration for a multicast service provided by a serving cell of the UE, the first PTM configuration identifying a first set of resources to monitor for the multicast service while the UE is in an RRC inactive state; receiving, via the RRC release message, an indication of whether a second PTM configuration for the multicast service is present for the serving cell of the UE, an indication of whether the second PTM configuration is different from the first PTM configuration, or both; and monitoring for the multicast service in accordance with the first PTM configuration or the second PTM configuration based at least in part on transitioning from an RRC connected state to the RRC inactive state in accordance with the RRC release message.
Aspect 2: The method of aspect 1, wherein monitoring for the multicast service comprises: monitoring for the multicast service in accordance with the first PTM configuration based at least in part on the RRC release message indicating that the second PTM configuration is the same as the first PTM configuration.
Aspect 3: The method of any of aspects 1 through 2, wherein monitoring for the multicast service comprises: monitoring for the multicast service in accordance with the first PTM configuration based at least in part on the RRC release message indicating that the second PTM configuration is absent for the serving cell of the UE.
Aspect 4: The method of any of aspects 1 through 3, wherein receiving the RRC release message comprises: receiving an indication of the first PTM configuration for the multicast service via dedicated signaling while the UE is in the RRC connected state.
Aspect 5: The method of any of aspects 1 through 4, wherein the indication of whether the second PTM configuration is present for the serving cell and whether the second PTM configuration is different from the first PTM configuration is applicable to a plurality of G-RNTIs.
Aspect 6: The method of any of aspects 1 through 5, wherein the indication of whether the second PTM configuration is present for the serving cell and whether the second PTM configuration is different from the first PTM configuration is signaled per G-RNTI.
Aspect 7: The method of any of aspects 1 through 6, further comprising: monitoring for a MCCH change notification to determine whether a PTM configuration change has occurred for the multicast service.
Aspect 8: The method of any of aspects 1 through 7, further comprising: receiving, while the UE is in the RRC inactive state, an indication of the second PTM configuration via a MCCH based at least in part on the RRC release message indicating that the second PTM configuration is different from the first PTM configuration.
Aspect 9: The method of any of aspects 1 through 8, further comprising: receiving a multicast SIB or a MCCH transmission indicating the second PTM configuration for the multicast service after transitioning to the RRC inactive state.
Aspect 10: The method of any of aspects 1 through 9, wherein the first PTM configuration is valid while the UE is transitioning from the RRC connected state to the RRC inactive state.
Aspect 11: The method of any of aspects 1 through 10, further comprising: periodically monitoring a MCCH to acquire the second PTM configuration for the multicast service provided by the serving cell of the UE.
Aspect 12: The method of aspect 11, further comprising: switching or updating a configuration of a MRB associated with the multicast service based at least in part on periodically monitoring the MCCH.
Aspect 13: The method of any of aspects 1 through 12, further comprising: determining a time period for which the first PTM configuration is valid.
Aspect 14: The method of aspect 13, wherein monitoring for the multicast service comprises: monitoring for the multicast service in accordance with the first PTM configuration prior to expiration of the time period; and monitoring for the multicast service in accordance with the second PTM configuration after expiration of the time period.
Aspect 15: The method of any of aspects 13 through 14, further comprising: refraining from monitoring a MCCH associated with the multicast service until the time period has elapsed.
Aspect 16: The method of any of aspects 13 through 15, further comprising: switching from a first MRB configuration associated with the first PTM configuration to a second MRB configuration associated with the second PTM configuration prior to expiration of the time period.
Aspect 17: The method of any of aspects 13 through 16, wherein a duration of the time period is fixed, configurable, configured by default, or equal to zero.
Aspect 18: The method of any of aspects 1 through 17, further comprising: refraining from switching to a MRB configuration associated with the second PTM configuration if the multicast service is stopped, deactivated, or temporarily suspended, wherein the MRB configuration is provided via a MCCH.
Aspect 19: The method of any of aspects 1 through 18, further comprising: receiving, while the UE is in the RRC connected state, an RRC reconfiguration message that indicates a MRB configuration associated with the first PTM configuration for the multicast service, wherein the RRC release message instructs the UE to re-use the MRB configuration for reception of the multicast service while the UE is in the RRC inactive state.
Aspect 20: The method of aspect 19, wherein the RRC release message further instructs the UE to release a P2P configuration or to deactivate a P2P leg of the MRB configuration provided via the RRC reconfiguration message.
Aspect 21: The method of any of aspects 19 through 20, further comprising: receiving an indication of a time duration for which the MRB configuration is valid; and monitoring for the multicast service in accordance with the MRB configuration until the time duration has elapsed.
Aspect 22: A method for wireless communications at a network entity, comprising: transmitting, via an RRC release message for a UE in an RRC connected state, an indication of a first PTM configuration for a multicast service provided by a cell associated with the network entity, the first PTM configuration identifying a first set of resources to monitor for the multicast service; transmitting, via the RRC release message, an indication of whether a second PTM configuration for the multicast service is present for the cell, an indication of whether the second PTM configuration is different from the first PTM configuration, or both; and transmitting one or more messages associated with the multicast service in accordance with the first PTM configuration or the second PTM configuration based at least in part on the RRC release message instructing the UE to transition from the RRC connected state to an RRC inactive state.
Aspect 23: The method of aspect 22, wherein transmitting the one or more messages associated with the multicast service comprises: transmitting the one or more messages associated with the multicast service in accordance with the first PTM configuration based at least in part on the RRC release message indicating that the second PTM configuration is the same as the first PTM configuration.
Aspect 24: The method of any of aspects 22 through 23, wherein transmitting the one or more messages associated with the multicast service comprises: transmitting the one or more messages associated with the multicast service in accordance with the first PTM configuration based at least in part on the RRC release message indicating that the second PTM configuration is absent for the cell.
Aspect 25: The method of any of aspects 22 through 24, wherein transmitting the RRC release message comprises: transmitting an indication of the first PTM configuration to the UE via dedicated signaling while the UE is in the RRC connected state.
Aspect 26: The method of any of aspects 22 through 25, wherein the indication of whether the second PTM configuration is present for the cell and whether the second PTM configuration is different from the first PTM configuration applies to a plurality of G-RNTIs.
Aspect 27: The method of any of aspects 22 through 26, wherein the indication of whether the second PTM configuration is present for the cell and whether the second PTM configuration is different from the first PTM configuration is signaled per G-RNTI.
Aspect 28: The method of any of aspects 22 through 27, further comprising: transmitting, via a MCCH, an indication of the second PTM configuration for the UE in the RRC inactive state based at least in part on the RRC release message indicating that the second PTM configuration is different from the first PTM configuration.
Aspect 29: An apparatus for wireless communications at a UE, comprising a processor, memory coupled with the processor, and instructions stored in the memory and executable by the processor to cause the apparatus to perform a method of any of aspects 1 through 21.
Aspect 30: An apparatus for wireless communications at a UE, comprising at least one means for performing a method of any of aspects 1 through 21.
Aspect 31: A non-transitory computer-readable medium storing code for wireless communications at a UE, the code comprising instructions executable by a processor to perform a method of any of aspects 1 through 21.
Aspect 32: An apparatus for wireless communications at a network entity, comprising a processor, memory coupled with the processor, and instructions stored in the memory and executable by the processor to cause the apparatus to perform a method of any of aspects 22 through 28.
Aspect 33: An apparatus for wireless communications at a network entity, comprising at least one means for performing a method of any of aspects 22 through 28.
Aspect 34: A non-transitory computer-readable medium storing code for wireless communications at a network entity, the code comprising instructions executable by a processor to perform a method of any of aspects 22 through 28.
Aspect 35: A method for wireless communications at a UE, comprising: receiving an indication of a first PTM configuration for a multicast service provided by a serving cell of the UE, the first PTM configuration identifying a first set of resources to monitor for the multicast service while the UE is in an RRC inactive state; receiving an RRC release message; and receiving one or more messages associated with the multicast service in accordance with the first PTM configuration or a second PTM configuration based at least in part on a transition from an RRC connected state to the RRC inactive state in accordance with the RRC release message.
Aspect 36: The method of aspect 35, wherein the indication of the second

PTM configuration is received via the RRC release message, and the one or more messages associated with the multicast service is received in accordance with the second PTM configuration.
Aspect 37: The method of any of aspects 35 through 36, further comprising: monitoring for a MCCH change notification to determine whether a PTM configuration change has occurred for the multicast service.
Aspect 38: The method of aspect 37, further comprising: receiving the MCCH change notification, wherein the indication of the second PTM configuration is received via a MCCH based at least in part on receiving the MCCH change notification, and wherein the one or more messages associated with the multicast service is received in accordance with the second PTM configuration.
Aspect 39: The method of any of aspects 35 through 38, wherein receiving the one or more messages associated with the multicast service comprises: receiving the one or more messages associated with the multicast service in accordance with the first PTM configuration based at least in part on the RRC release message indicating that the second PTM configuration is the same as the first PTM configuration.
Aspect 40: The method of any of aspects 35 through 39, wherein monitoring for the multicast service comprises: receiving the one or more messages associated with the multicast service in accordance with the first PTM configuration based at least in part on the RRC release message indicating that the second PTM configuration is absent for the serving cell of the UE.
Aspect 41: The method of any of aspects 35 through 40, wherein receiving the RRC release message comprises: receiving the RRC release message via dedicated signaling while the UE is in the RRC connected state.
Aspect 42: The method of any of aspects 35 through 41, further comprising: determining a time period for which the second PTM configuration is valid.
Aspect 43: The method of aspect 42, wherein monitoring for the multicast service comprises: receiving the one or more messages associated with the multicast service in accordance with the second PTM configuration prior to expiration of the time period; and receiving the one or more messages associated with the multicast service in accordance with the first PTM configuration after expiration of the time period.
Aspect 44: The method of any of aspects 42 through 43, further comprising: refraining from monitoring a MCCH associated with the multicast service until the time period has elapsed.
Aspect 45: The method of any of aspects 42 through 44, further comprising:

switching from a first MRB configuration associated with the first PTM configuration to a second MRB configuration associated with the first PTM configuration prior to expiration of the time period.
Aspect 46: The method of any of aspects 42 through 45, wherein a duration of the time period is fixed, configurable, configured by default, or equal to zero.
Aspect 47: The method of any of aspects 50 through 46, further comprising: receiving an indication of a time duration for which a MRB configuration is valid; and monitoring for the multicast service in accordance with the MRB configuration until the time duration has elapsed.
Aspect 48: A method for wireless communications at a network entity, comprising: transmitting, for a UE in an RRC connected state, an indication of a first PTM configuration for a multicast service provided by a cell associated with the network entity, the first PTM configuration identifying a first set of resources to monitor for the multicast service; transmitting an RRC release message; and transmitting one or more messages associated with the multicast service in accordance with the first PTM configuration or a second PTM configuration based at least in part on the RRC release message instructing the UE to transition from the RRC connected state to an RRC inactive state.
Aspect 49: The method of aspect 48, wherein the indication of the second PTM configuration is transmitted via the RRC release message, and the one or more messages associated with the multicast service is transmitted in accordance with the second PTM configuration.
Aspect 50: The method of any of aspects 48 through 49, further comprising: transmitting a MCCH change notification, wherein the indication of the second PTM configuration is transmitted via a multicast control channel, and wherein the one or more messages associated with the multicast service is transmitted in accordance with the second PTM configuration.
Aspect 51: The method of any of aspects 48 through 50, wherein transmitting the one or more messages associated with the multicast service comprises: transmitting the one or more messages associated with the multicast service in accordance with the first PTM configuration based at least in part on the RRC release message indicating that the second PTM configuration is the same as the first PTM configuration.
Aspect 52: The method of any of aspects 48 through 51, wherein transmit the one or more messages associated with the multicast service comprises: transmitting the one or more messages associated with the multicast service in accordance with the first PTM configuration based at least in part on the RRC release message indicating that the second PTM configuration is absent for the cell.
Aspect 53: The method of any of aspects 48 through 52, wherein transmitting the RRC release message comprises: transmitting the RRC release message via dedicated signaling while the UE is in the RRC connected state.
Aspect 54: A UE for wireless communications, comprising one or more memories storing processor-executable code, and one or more processors coupled with the one or more memories and individually or collectively operable to execute the code to cause the UE to perform a method of any of aspects 35 through 47.
Aspect 55: A UE for wireless communications, comprising at least one means for performing a method of any of aspects 35 through 47.
Aspect 56: A non-transitory computer-readable medium storing code for wireless communications, the code comprising instructions executable by one or more processors to perform a method of any of aspects 35 through 47.
Aspect 57: A network entity for wireless communications, comprising one or more memories storing processor-executable code, and one or more processors coupled with the one or more memories and individually or collectively operable to execute the code to cause the network entity to perform a method of any of aspects 48 through 53.
Aspect 58: A network entity for wireless communications, comprising at least one means for performing a method of any of aspects 48 through 53.
Aspect 59: A non-transitory computer-readable medium storing code for wireless communications, the code comprising instructions executable by one or more processors to perform a method of any of aspects 48 through 53.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
one or more processors;
memory coupled with the one or more processors; and
instructions stored in the memory and executable by the one or more processors to cause the apparatus to:
receive an indication of a first point-to-multipoint configuration for a multicast service provided by a serving cell of the UE, the first point-to-multipoint configuration identifying a first set of resources to monitor for the multicast service while the UE is in a radio resource control (RRC) inactive state;
receive an RRC release message; and
receive one or more messages associated with the multicast service in accordance with the first point-to-multipoint configuration or a second point-to-multipoint configuration based at least in part on a transition from an RRC connected state to the RRC inactive state in accordance with the RRC release message.

2. The apparatus of claim 1, wherein the indication of the second point-to-multipoint configuration is received via the RRC release message, and wherein the one or more messages associated with the multicast service is received in accordance with the second point-to-multipoint configuration.

3. The apparatus of claim 1, wherein the instructions are further executable by the one or more processors to cause the apparatus to:
monitor for a multicast control channel change notification to determine whether a point-to-multipoint configuration change has occurred for the multicast service.

4. The apparatus of claim 3, wherein the instructions are further executable by the one or more processors to cause the apparatus to:
receive the multicast control channel change notification, wherein the indication of the second point-to-multipoint configuration is received via a multicast control channel based at least in part on the multicast control channel change notification, and wherein the one or more messages associated with the multicast service is received in accordance with the second point-to-multipoint configuration.

5. The apparatus of claim 1, wherein, to receive the one or more messages associated with the multicast service, the instructions are executable by the one or more processors to cause the apparatus to:
receive the one or more messages associated with the multicast service in accordance with the first point-to-multipoint configuration based at least in part on the RRC release message indicating that the second point-to-multipoint configuration is the same as the first point-to-multipoint configuration.

6. The apparatus of claim 1, wherein, to monitor for the multicast service, the instructions are executable by the one or more processors to cause the apparatus to:
receive the one or more messages associated with the multicast service in accordance with the first point-to-multipoint configuration based at least in part on the RRC release message indicating that the second point-to-multipoint configuration is absent for the serving cell of the UE.

7. The apparatus of claim 1, wherein, to receive the RRC release message, the instructions are executable by the one or more processors to cause the apparatus to:
receive the RRC release message via dedicated signaling while the UE is in the RRC connected state.

8. The apparatus of claim 1, wherein the instructions are further executable by the one or more processors to cause the apparatus to:
determine a time period for which the second point-to-multipoint configuration is valid.

9. The apparatus of claim 8, wherein, to monitor for the multicast service, the instructions are executable by the one or more processors to cause the apparatus to:
receive the one or more messages associated with the multicast service in accordance with the second point-to-multipoint configuration prior to expiration of the time period; and
receive the one or more messages associated with the multicast service in accordance with the first point-to-multipoint configuration after expiration of the time period.

10. The apparatus of claim 8, wherein the instructions are further executable by the one or more processors to cause the apparatus to:
refrain from monitoring a multicast control channel associated with the multicast service until the time period has elapsed.

11. The apparatus of claim 8, wherein the instructions are further executable by the one or more processors to cause the apparatus to:
switch from a first multicast radio bearer configuration associated with the first point-to-multipoint configuration to a second multicast radio bearer configuration associated with the first point-to-multipoint configuration prior to expiration of the time period.

12. The apparatus of claim 8, wherein:
a duration of the time period is fixed, configurable, configured by default, or equal to zero.

13. The apparatus of claim 1, wherein the instructions are further executable by the one or more processors to cause the apparatus to:
receive an indication of a time duration for which a multicast radio bearer configuration is valid; and
monitor for the multicast service in accordance with the multicast radio bearer configuration until the time duration has elapsed.

14. An apparatus for wireless communications at a network entity, comprising:
one or more processors;
memory coupled with the one or more processors; and
instructions stored in the memory and executable by the one or more processors to cause the apparatus to:
transmit, for a user equipment (UE) in a radio resource control (RRC) connected state, an indication of a first point-to-multipoint configuration for a multicast service provided by a cell associated with the network entity, the first point-to-multipoint configuration identifying a first set of resources to monitor for the multicast service;
transmit an RRC release message; and
transmit one or more messages associated with the multicast service in accordance with the first point-to-multipoint configuration or a second point-to-multipoint configuration based at least in part on the RRC release message instructing the UE to transition from the RRC connected state to an RRC inactive state.

15. The apparatus of claim 14, wherein the indication of the second point-to-multipoint configuration is transmitted via the RRC release message, and wherein the one or more messages associated with the multicast service is transmitted in accordance with the second point-to-multipoint configuration.

16. The apparatus of claim 14, wherein the instructions are further executable by the one or more processors to cause the apparatus to:
transmit a multicast control channel change notification, wherein the indication of the second point-to-multipoint configuration is transmitted via a multicast control channel, and wherein the one or more messages associated with the multicast service is transmitted in accordance with the second point-to-multipoint configuration.

17. The apparatus of claim 14, wherein, to transmit the one or more messages associated with the multicast service, the instructions are executable by the one or more processors to cause the apparatus to:
transmit the one or more messages associated with the multicast service in accordance with the first point-to-multipoint configuration based at least in part on the RRC release message indicating that the second point-to-multipoint configuration is the same as the first point-to-multipoint configuration.

18. The apparatus of claim 14, wherein, to transmit the one or more messages associated with the multicast service, the instructions are executable by the one or more processors to cause the apparatus to:
transmit the one or more messages associated with the multicast service in accordance with the first point-to-multipoint configuration based at least in part on the RRC release message indicating that the second point-to-multipoint configuration is absent for the cell.

19. The apparatus of claim 14, wherein, to transmit the RRC release message, the instructions are executable by the one or more processors to cause the apparatus to:
transmit the RRC release message via dedicated signaling while the UE is in the RRC connected state.

20. A method for wireless communications at a user equipment (UE), comprising:
receiving an indication of a first point-to-multipoint configuration for a multicast service provided by a serving cell of the UE, the first point-to-multipoint configuration identifying a first set of resources to monitor for the multicast service while the UE is in a radio resource control (RRC) inactive state;
receiving an RRC release message; and
receiving one or more messages associated with the multicast service in accordance with the first point-to-multipoint configuration or a second point-to-multipoint configuration based at least in part on a transition from an RRC connected state to the RRC inactive state in accordance with the RRC release message.
